(19) United States
(12) Patent Application Publication
(10) Pub. No.: US 2024/0061228 A1
(43) Pub. Date: Feb. 22, 2024

(54) HIGH-SPEED ROTARY/GALVO PLANAR-MIRROR-BASED OPTICAL-PATH-LENGTH-SHIFT SUBSYSTEM AND METHOD, AND RELATED SYSTEMS AND METHODS

(71) Applicant: Optonomous Technologies, Inc., Agoura Hills, CA (US)

(72) Inventor: Kenneth Li, Agoura Hills, CA (US)

(21) Appl. No.: 18/271,423

(22) PCT Filed: Jan. 5, 2022
(86) PCT No.: PCT/US2022/011348

§ 371 Date: Jul. 7, 2023

Related U.S. Application Data
(60) Provisional application No. 63/135,554, filed on Jan. 8, 2021.

(51) Int. Cl. G02B 21/06; G02B 30/52; G02B 30/54; G02B 30/56

(52) U.S. Cl. CPC G02B 21/06; G02B 30/52; G02B 30/54; G02B 30/56

(57) ABSTRACT

Planar-mirror-based focus-shift systems usable for various microscope systems including confocal microscopes, fluorescent microscopes, etc., as well as 3D “floating image” display devices. The invention provides light-sheet-illumination systems for 3D applications, using high-speed focal-plane adjustment synchronized to the scanning light sheet to quickly capture a 3D representation, which is especially important for live samples that move. 2D images of an object are captured, and the third dimension is obtained by changing the focal plane used for each image. A series of the 2D images are used to obtain a 3D representation, which optionally is a moving 3D representation of a live moving specimen. Some embodiments provide constant magnification by compensating the magnification factor of one optical focus-shift subsystem by an opposing magnification factor of another focus-shift subsystem. Some embodiments provide a display system that uses a stationary display and a focus-shift subsystem to output a 3D “floating image.”

### CROSS-REFERENCE TO RELATED APPLICATIONS

This application claims priority benefit, including under 35 U.S.C. § 119(e), of U.S. Provisional Patent Application 63/135,554, filed Jan. 8, 2021 by Kenneth Li and titled “High Speed Rotary/Galvo Planar Mirror-Based Focus Shift System Microscope System,” which is incorporated herein by reference in its entirety.

This application is related to:
PCT Patent Application No. PCT/US2021/016960, filed Feb. 5, 2021 by Kenneth Li et al., titled “Scanner System and Method having Adjustable Path Length with Constant Input and Output Optical Axes” (published Aug. 19, 2021 as WO 2021/162958);
U.S. Provisional Patent Application 62/972,553 titled “Scanner System Allowing Change in Path Length with Constant Input and Output Optical Axes,” by Kenneth Li, filed Feb. 10, 2020;
U.S. Provisional Patent Application 63/106,813 titled “Scanner System with Variable Path Length for Microscope Focusing,” by Kenneth Li, filed Oct. 28, 2020; and
U.S. Provisional Patent Application 63/125,357 titled “Scanner System with Variable Path Length for Microscope Focusing,” by Kenneth Li, filed Dec. 14, 2020;
   each of which is incorporated herein by reference in its entirety.

### FIELD OF THE INVENTION

This invention relates to the field of optical-focus systems, and more specifically to a method and apparatus to quickly change an optical-path length using one or more high-speed rotary-motor or galvanometer actuators to rotate one or more sets of planar mirrors for such applications as: (1) a focus-shift subsystem that, in some embodiments, maintains a constant magnification while changing a focal length for a microscope objective that is optionally configured to synchronize with a light-sheet-movement subsystem and an image-acquisition subsystem usable to obtain a plurality of high-resolution two-dimensional (2D) images that can be manipulated and assembled into a three-dimensional (3D) still or moving representation of an object, wherein the synchronized subsystems are particularly useful for various types of light-sheet microscopes, including confocal, fluorescent, and the like, and for uses such as imaging in vivo biological specimens, and (2) an optical-path-length subsystem that is usable with a liquid-crystal display (LCD) to make a 3D volumetric display system that outputs a viewable “floating-image” representation of an object from almost any field of expertise, e.g., medical, biological research, mechanical designs, and so forth.

### BACKGROUND OF THE INVENTION

This application is also related to:
U.S. Provisional Patent Application 62/916,580 titled “Recycling Light System using Total Internal Reflection to Increase Brightness of a Light Source,” filed Oct. 17, 2019, by Kenneth Li;
U.S. Provisional Patent Application 62/763,423 titled “Laser Excited Crystal Phosphor Light Module,” filed Jun. 14, 2018 by Yung Peng Chang et al.,
U.S. Provisional Patent Application 62/764,085 titled “Laser Excited Crystal Phosphor Light Source with Side Excitation,” filed Jul. 18, 2018 by Yung Peng Chang et al.,
U.S. Provisional Patent Application 62/764,090 titled “Laser Excited RGB Crystal Phosphor Light Source,” filed Jul. 18, 2018 by Yung Peng Chang et al.,
U.S. Provisional Patent Application 62/766,209 titled “Laser Phosphor Light Source for Intelligent Headlights and Spotlights,” filed Oct. 5, 2018 by Yung Peng Chang et al.,
P.C.T. Patent Application No. PCT/US2020/037669, titled “HYBRID LED/LASER LIGHT SOURCE FOR SMART HEADLIGHT APPLICATIONS,” filed Jun. 14, 2020 by Kenneth Li et al. (published Dec. 24, 2020 as WO 2020/257091),
U.S. Provisional Patent Application 62/862,549 titled “ENHANCEMENT OF LED INTENSITY PROFILE USING LASER EXCITATION,” filed Jun. 17, 2019, by Kenneth Li;
U.S. Provisional Patent Application 62/874,943 titled “ENHANCEMENT OF LED INTENSITY PROFILE USING LASER EXCITATION,” filed Jul. 16, 2019, by Kenneth Li;
U.S. Provisional Patent Application 62/938,863 titled “DUAL LIGHT SOURCE FOR SMART HEADLIGHT APPLICATIONS,” filed Nov. 21, 2019, by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;
P.C.T. Patent Application No. PCT/US2020/034447, filed May 24, 2020 by Y. P. Chang et al., titled “LiDAR INTEGRATED WITH SMART HEADLIGHT AND METHOD” (published Dec. 3, 2020 as WO 2020/243038);
U.S. Provisional Patent Application No. 62/853,538, filed May 28, 2019 by Y. P. Chang et al., titled “LIDAR Integrated With Smart Headlight Using a Single DMD”;
U.S. Provisional Patent Application No. 62/857,662, filed Jun. 5, 2019 by Chun-Nien Liu et al., titled “Scheme of LIDAR-Embedded Smart Laser Headlight for Autonomous Driving”;
U.S. Provisional Patent Application No. 62/950,080, filed Dec. 18, 2019 by Kenneth Li, titled “Integrated LIDAR and Smart Headlight using a Single MEMS Mirror”;
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);
U.S. patent application Ser. No. 16/509,196 titled “ILLUMINATION SYSTEM WITH HIGH INTENSITY PROJECTION MECHANISM AND METHOD OF OPERATION THEREOF,” filed Jul. 11, 2019, by Y. P. Chang et al. (issued Aug. 25, 2020 as U.S. Pat. No. 10,754,236);
U.S. Provisional Patent Application 62/837,077 titled “LASER EXCITED CRYSTAL PHOSPHOR SPHERE LIGHT SOURCE,” filed Apr. 22, 2019, by Kenneth Li et al.;
U.S. Provisional Patent Application 62/853,538 titled “LIDAR INTEGRATED WITH SMART HEADLIGHT USING A SINGLE DMD,” filed May 28, 2019, by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/903,620 titled “RGB LASER LIGHT SOURCE FOR PROJECTION DISPLAYS,” filed Sep. 20, 2019, by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS” (published Dec. 13, 2020 as WO 2020/247291); each of which is incorporated herein by reference in its entirety.

U.S. Pat. No. 8,699,141 issued to Aschwanden et al. on Apr. 15, 2014 with the title “Lens assembly apparatus and method” and is incorporated herein by reference. U.S. Pat. No. 8,699,141 describes an optical apparatus that includes a first membrane, a second membrane and at least one electromagnetically displaceable component. The first membrane includes an optically active area. The first membrane and the second membrane are coupled by a filler material disposed in a reservoir. At least one electromagnetically displaceable component is coupled to the filler material via the second membrane, such that a displacement of the at least one electromagnetically displaceable component is operative to cause a deformation of the optically active area of the first membrane by movement of the filler material.

U.S. Pat. No. 7,933,056 issued to Tsao on Apr. 26, 2011 with the title “Methods and systems of rapid focusing and zooming for volumetric 3D displays and cameras” and is incorporated herein by reference. U.S. Pat. No. 7,933,056 describes methods and systems of rapid focusing and zooming for the applications in the projection of volumetric 3D images and in the imaging of 3D objects. Rapid variable focusing or zooming is achieved by rapid and repeated change of the object distance or the spacing between lens groups of the projection lens or a combination of both. One preferred approach inserts thin wedge prisms into the optical path and changes their positions relative to the optical path. This changes the thickness traveled through by the optical path and results in effective optical path length change. Another approach folds an optical path by mirrors and moves the mirrors to change the optical path length. For focusing purpose, small and precise displacement is achieved by moving a wedge-shaped optical device obliquely with respect to the optical path. The wedge-shaped optical device can be a thin wedge prism or a mirror on a wedge-shaped base. Optical layout analysis shows that the changes of the object distance, of the spacing between two lens groups and of the image distance are almost in proportion and can be correlated by linear relations. U.S. Pat. No. 7,933,056 asserts the same type of motion function can be used to change these three optical path lengths to achieve focusing and constant magnification.

There is a need in the art for microscope focus systems that have improved speed and image quality, and for improved 3D volumetric displays that generate a viewable “floating-image” representation of an object.

### SUMMARY OF THE INVENTION

In some embodiments (such as shown in FIG. 20, for example), the present invention provides a first apparatus that includes: an emissive display panel, such as OLED (organic light-emitting diode) panel, mini-LED panel, micro-LED panel, or a display panel having a light source that illuminates the display panel to generate a first patterned optical beam; a fixed-in-place pair of orthogonally mounted planar mirrors at a fixed first location relative to the display panel; a first focusing optical element positioned at a fixed second location relative to the display panel; a second focusing optical element positioned at a fixed third location relative to the display panel; a rotating platform having one or more pairs of orthogonally mounted planar mirrors affixed to the rotating platform, wherein the first patterned optical beam is projected toward a location that is repeatedly scanned and retroreflected, by the one or more pairs of orthogonally mounted planar mirrors affixed to the rotating platform, toward the fixed-in-place pair of orthogonally mounted planar mirrors, wherein the one or more pairs of orthogonally mounted planar mirrors affixed to the rotating platform are configured: to retroreflect the first patterned optical beam toward the fixed-in-place pair of orthogonally mounted planar mirrors, which are configured to retroreflect to form a second patterned optical beam that is laterally displaced from the first optical beam, and that is antiparallel to the first optical beam, and to retroreflect the second optical beam toward the first focusing optical element, and wherein the first focusing optical element is configured to focus the second patterned optical beam toward the second focusing optical element, and wherein the second focusing optical element is configured to form a floating image based on the enlarged second patterned optical beam.

In some embodiments (such as shown in FIGS. 6A-16, for example), the present invention provides a second apparatus that includes: a microscope objective lens; a first optical-path-length-adjustment system that includes: a first rotatable mirror assembly that is rotatable to a plurality of different angles and that is operably coupled: to receive an input optical beam from the microscope objective that propagates along an input optical axis that passes through a defined input point, and to form a first intermediate beam that is antiparallel to the input optical beam, wherein the first mirror assembly includes two planar mirrors mounted at right angles to one another; and a second mirror assembly that is in a fixed position and orientation relative to the input beam, and that is operably coupled to receive the first intermediate beam and to form a second intermediate beam that is antiparallel to the first intermediate beam and laterally offset from the first intermediate beam, wherein the first mirror assembly is operably coupled to receive the second intermediate beam and to form an output beam that propagates along an output optical axis that passes through a defined output point and remains in a fixed position and angular orientation as the first optical-beam-deflection assembly is rotated to any of the plurality of different angles in order to change a first optical path length between the defined input point and the defined output point, and an imaging device operably coupled to receive the output beam and configured to generate a plurality of 2D images of an object, wherein each one of plurality of 2D images is focused at a different focal length from the microscope objective lens. In some embodiments, these plurality of 2D images are processed digitally and displayed as a 3D image with the desired perspectives.

In some embodiments, a second optical-path-length-adjustment system is added to compensate for changes in magnification factor of the first optical-path-length-adjustment system in order to obtain constant magnification across a range of optical-path-length changes.

In some embodiments, rotary-mirror systems are integrated with collimating lenses, reducing the size of the package and the system as a whole.

### BRIEF DESCRIPTION OF THE DRAWINGS

FIG. 1A is a cross-section view of 3D light-sheet microscope system 101, according to some embodiments of the present invention.

FIG. 1B is a cross-section view of 3D light-sheet microscope system 102, according to some embodiments of the present invention.

FIG. 1C is a cross-section view of 3D light-sheet microscope system 103, according to some embodiments of the present invention.

FIG. 2 is a cross-section view of microscope system 201 that focuses an image from focal plane 211 onto CCD imager 240, according to some embodiments of the present invention.

FIG. 3 is a cross-section view of microscope system 301 that focuses an image from focal plane 311 onto CCD imager 340, according to some embodiments of the present invention.

FIG. 4 is a side view of microscope objective 401 that forms a converging output that forms a diverging output beam 413 from focal plane 430, according to some embodiments of the present invention.

FIG. 5A is a side-view cross-sectional block diagram of a two-lens optical arrangement 501 that has an input beam 512 having parallel rays and an output beam 510 having parallel rays.

FIG. 5B is a side-view cross-sectional block diagram of a two-lens optical arrangement 502 that has an input beam 511 having convergent rays and an output beam 510 having parallel rays.

FIG. 5C is a side-view cross-sectional block diagram of a two-lens optical arrangement 503 that has an input beam 513 having divergent rays and an output beam 510 having parallel rays.

FIG. 6A is a perspective-view block diagram of a retroreflector optical-path-length-adjustment system 601 that uses a rotatable flat-mirror retroreflector 610 which rotates to change the optical-path length, and a fixed-position flat-mirror retroreflector 620, shown here with retroreflector 610 in a first rotational orientation of a plurality of possible rotational orientations, according to some embodiments of the present invention.

FIG. 6B is a side-view cross-sectional block diagram of flat-mirror retroreflector optical-path-length-adjustment system 601 with retroreflector 610 in the first rotational orientation.

FIG. 6C is a top-view cross-sectional block diagram of retroreflector optical-path-length-adjustment system 601 with retroreflector 610 in the first rotational orientation.

FIG. 6D is a side-view cross-sectional block diagram of flat-mirror retroreflector optical-path-length-adjustment system 601 with retroreflector 610 in a first rotational orientation labeled 610A and in a second rotational orientation labeled 610B of the plurality of possible rotational orientations.

FIG. 7A is a top-view cross-sectional block diagram of a rotating retroreflector optical-path-length-adjustment system 701 with retroreflector 710 in a first rotational orientation labeled 710A and in a second rotational orientation labeled 710B, according to some embodiments of the present invention.

FIG. 7B is a side-view cross-sectional block diagram of a rotating retroreflector optical-path-length-adjustment system 701.

FIG. 8A is a top-view cross-sectional block diagram of a rotating retroreflector optical-path-length-adjustment system 801 with first retroreflector 810 in a first rotational orientation labeled 810A and in a second rotational orientation labeled 810B, according to some embodiments of the present invention.

FIG. 8B is a side-view cross-sectional block diagram of a microscope imaging system 802 that uses a rotating retroreflector optical-path-length-adjustment system 801, according to some embodiments of the present invention.

FIG. 9 is a side-view cross-sectional block diagram of a microscope imaging system 901 that uses an oscillating retroreflector optical-path-length-adjustment system 940, according to some embodiments of the present invention.

FIG. 10 is a graph 1001 of focus shift versus rotational angle for one type of microscope imaging system, according to some embodiments of the present invention.

FIG. 11 is a graph 1101 of magnification versus rotational angle for one type of microscope imaging system, according to some embodiments of the present invention.

FIG. 12 is a side-view cross-sectional block diagram of yet another microscope imaging system 1201 that uses two optical-path-length-adjustment systems 1238 and 1328′, according to some embodiments of the present invention.

FIG. 13 is a side-view cross-sectional block diagram of yet another microscope imaging system 1301 that uses two retroreflector optical-path-length-adjustment systems 940 and 940′, according to some embodiments of the present invention.

FIG. 14 is a side-view cross-sectional block diagram of an optical-path-length-adjustment imaging system 1401 that uses two coupled side-by-side oscillatory retroreflectors 1410 and 1410′ that use a single shared oscillatory rotational stage 1415, according to some embodiments of the present invention.

FIG. 15 is a side-view cross-sectional block diagram of yet another microscope imaging system 1501 that uses two rotating optical-path-length-adjustment systems 701 and 701′ that together use a single shared motor 788 driving a stacked rotating rotational platform 780 and 780′ and having relay lenses 731, 732, 731′, and 732′ inside the rotating retroreflectors 710, 720, 710′, and 720′, according to some embodiments of the present invention.

FIG. 16 is a side-view cross-sectional block diagram of still another microscope imaging system 1601 that uses two rotating optical-path-length-adjustment systems 801 and 801′ that together use a single motor 888 driving a stacked rotating rotational platform 880 having relay lenses 831, 832, 831′, and 832′ microscope objective lens 850 and the image acquisition system 840 outside the rotating sets of mirrors 801 and 801′, according to some embodiments of the present invention.

FIG. 17 is a drawing 1701 of a photomicrograph that showed an image of iPhone pixels used in experiments, demonstrating results of optimization and measured results.

FIG. 18 is a side-view cross-sectional block diagram of an optical-path-length-changing subsystem 1801 having a changeable optical-path length that uses a rotating platform 1880 having one or more retroreflecting sets of mirrors 1810 (and optionally retroreflecting mirrors 1820 and possibly others), according to some embodiments of the present invention.

FIG. 19 is a side-view cross-sectional block diagram of an imaging system 1901 having a changeable optical-path length that generates a floating image 1980, according to some embodiments of the present invention.

FIG. 20 is a side-view cross-sectional block diagram of an imaging subsystem 2001 having a changeable optical-path length that, when combined with generates a floating image 2080, according to some embodiments of the present invention.

### DETAILED DESCRIPTION OF PREFERRED EMBODIMENTS OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In some embodiments, there are several features combined into this invention making this invention uniquely advantageous over other designs:
Light-sheet microscopy—also referred to as single-plane-illumination microscopy (SPIM)—is a way of imaging sensitive samples or fast biological processes in vivo.

The planar mirror-based focus shift system of the present invention is usable for various microscope systems including light-sheet microscopes, confocal microscopes, fluorescent microscopes, phase-contrast microscopes, etc., as well as other optical systems such as binoculars, cameras and the like. In many applications, e.g., light-sheet-illumination systems for 3D applications, high-speed focal-plane adjustment is required, such that the imaging portion of the system synchronizes to the scanning light sheet to minimize movement of the sample during the recording period, which is especially important for live samples. Two-dimensional (2D) images are captured by, e.g., CMOS, cameras and the third dimension is usually obtained by changing the focal plane in the z-axis, optionally including moving the sample up-and-down around the focal plane, moving the objective lens, or changing the focal length of the optical train using electrically tunable lenses (ETL).

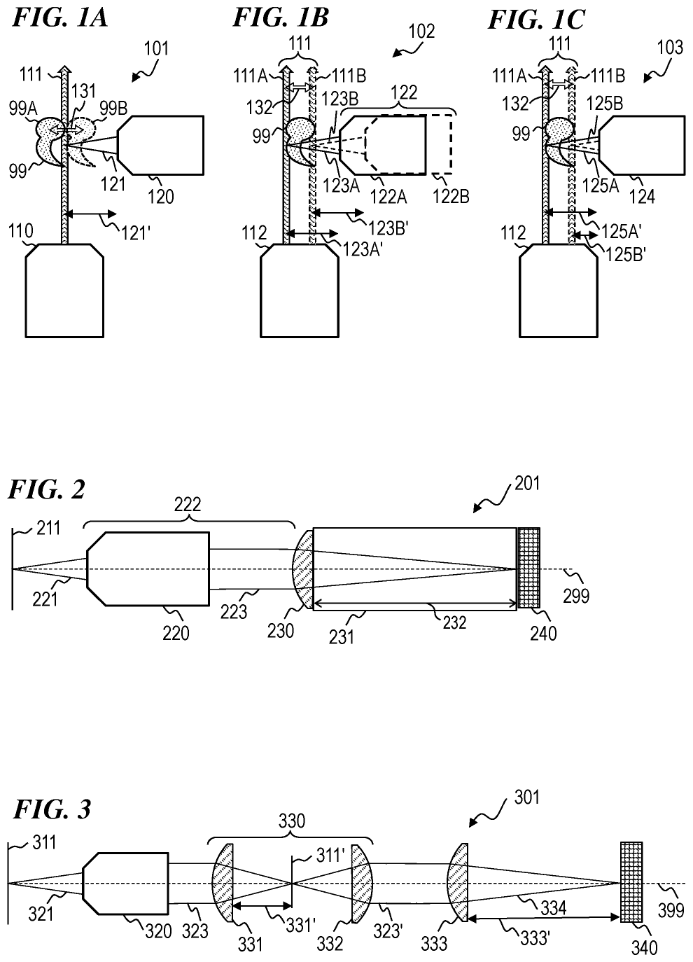

Three-dimensional (3D) microscopy is an important capability, allowing the visualization of microscopic structures. Three common methods are used for light-sheet microscopes, as shown in FIGS. 1A-1C.

FIG. 1A is a cross-section view of 3D light-sheet microscope system 101 that moves sample 99 relative to a stationary light sheet 111 and a fixed focal distance 121′ of a stationary microscope imaging objective 120, according to some embodiments of the present invention. 3D light-sheet microscope system 101 uses a first method where the sample 99 is moved across a range of positions between positions 99A and 99B as shown in FIG. 1A, with a fixed-focus stationary microscope objective 120 and a fixed-position light sheet 111 from a stationary light-sheet objective 110, and a plurality of 2D images is obtained, one at each of a plurality of positions of sample 99. The plurality of 2D images are then combined using known methods to generate a 3D image of sample 99.

FIG. 1B is a cross-section view of 3D light-sheet microscope system 102 that keeps sample 99 in a fixed position and moves light sheet 111 across a range 132 of distances between position 111A and 111B and that moves microscope imaging objective 122 having fixed focal distance 121′ between positions 122A and 122B, according to some embodiments of the present invention. 3D light-sheet microscope system 102 uses a second method that includes moving the microscope objective 122 between positions 122A and 122B in synchrony with moving light sheet 111 between positions 111A and 111B, while keeping the sample 99 stationary.

FIG. 1C is a cross-section view of 3D light-sheet microscope system 103 that moves light sheet 111 across a range 132 of distances between position 111A and 111 and that changes the focal distance of microscope imaging objective 124 having a range of focal distances between 125A′ and 125B′, according to some embodiments of the present invention. 3D light-sheet microscope system 103 uses a third method that includes changing the focal length of microscope objective 124 across a range of focal distances between 125A′ and 125B′, thus shifting the focus of microscope objective 124 between focus 125A and 125B in synchrony with moving light sheet 111 that moves between positions 111A and 111B, while keeping the microscope objective 124 and the sample 99 stationary. Various methods have been developed to achieve this focus shift and it has become a preferred method. Both methods shown in FIG. 1A and FIG. 1B require movements of relatively heavy objects (i.e., the sample holder moves when using the method of FIG. 1A, while the microscope objective 122 moves when using the method of FIG. 1B), which can be slow and the possibility of vibrations introduced by the moving mechanism make obtaining good images difficult. Moving the sample, as shown in FIG. 1A, introduces further issues as the sample 99 could be suspended in an air, liquid, or gel medium, which further amplifies the problem with movements and vibrations of the medium. An electrically tunable lens (ETL) using a deformable liquid lens has been used (see, e.g., U.S. Pat. No. 8,699,141, referenced above), which provides a simple method of focus shift, as a very small and fast mechanism is used to change the focal length. Some of the disadvantages are the distortions and chromatic aberrations introduced by such a simple lens filled with liquid.

The present invention introduces two high-speed systems and methods of introducing focus shift, as shown in FIG. 1C. using only retroreflectors with planar mirrors so as to avoid the introduction of distortions and chromatic aberrations. One system and method mounts a retroreflector that includes two light-weight planar mirrors onto a high-speed galvo-motor. The other system and method mounts the retroreflector on a high-speed rotary platform. The systems of the present invention have been demonstrated to provide the focus-shift function operating inside a microscope.

FIG. 2 is a cross-section block diagram of an optical system 201 that shows a basic microscope structure using an infinity-corrected optical system 222. The sample object (not shown) at the focal plane 211 is imaged by the objective 220 at infinity (thus optical beam section 223 has parallel lines) and is received by the tube lens 230 connected to tube 231 and the CCD camera imager 240. The lens tube 231 has a length equal to the focal length 232 of the tube lens 230 such that the image at infinity is focused onto the CCD camera imager 240. The advantage of such a system is that any image at infinity will be in focus at the CCD camera imager 240. Optical elements can be added in between the objective 220 and the tube lens 230 and the image will be in focus as long as the additional elements produce an infinity image. FIG. 3 shows a microscope system 301 in which a relay lens system 330 is added such that an infinity image beam 323′ is produced at the output of the relay lens system.

FIG. 3 is a cross-section view of microscope system 301 that focuses an image from focal plane 311 onto CCD imager 340, according to some embodiments of the present invention. In system 301, an image of the sample object (not shown) at focal plane 311 is formed at the focal point (plane 311′ being at focal distance 331′ from lens 331) of relay lens 331. When the focal point of the relay lens 332 is at this image plane 311′, the output of relay lens 332 will be an image at infinity (thus section 323′ has parallel lines), so tube lens 333 having focal length 334 is spaced from CCD 340 (the plane of CCD 340 being at focal distance 333′ from lens 333) and the image of the sample object will be in focus at the CCD camera imager 340.

Focus-Shift Optical System

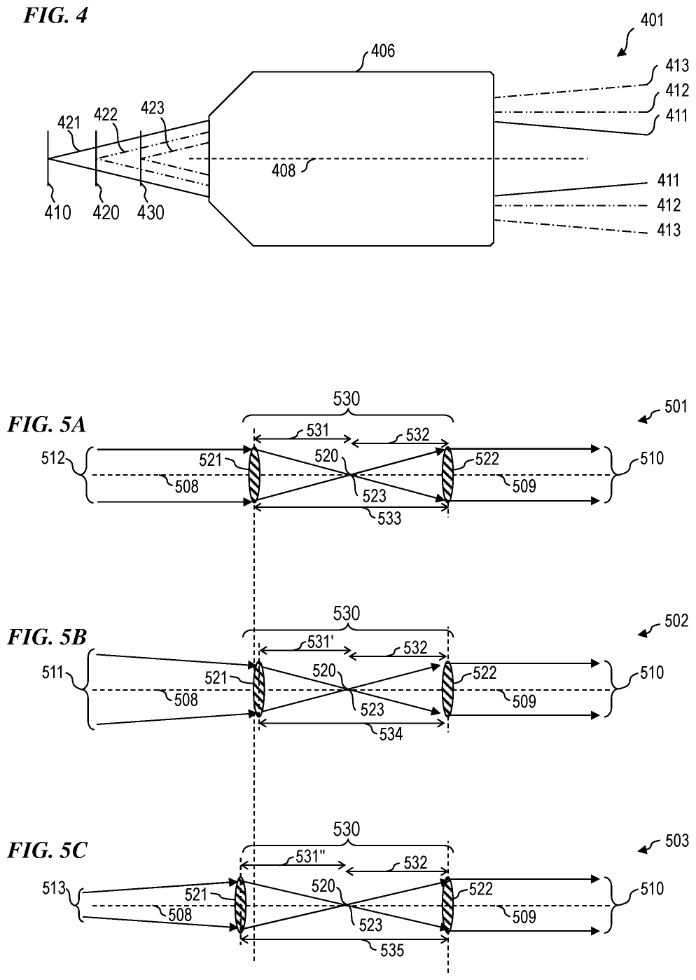

One common method of focusing a microscope system is to move the objective lens system axially along its optical axis such that the plane of interest of the sample object falls at the focus of the system. If a different plane of the sample object needs to be viewed, the objective is moved accordingly, such that the focus falls onto the new object plane. This is not a difficult issue when the system is adjusted manually. On the other hand, when the system is an automatic system, such adjustments requires motors or actuators to move the objective and the associated components, which can be slow as the components can be heavy. As a result, development efforts are placed mainly on non-mechanical means. The basics of a focus-shift system is shown in FIG. 4.

FIG. 4 is a side view of microscope objective 401 that forms a converging output that forms a diverging output beam 413 from focal plane 430, according to some embodiments of the present invention. Assuming that the designed location of the focal point is at 420, the output image will be at infinity with the output beam 412 being parallel to the optical axis 408. When the object is moved away from the objective 406 to focal plane 410, the output image will be at a finite distance from objective 406, resulting in a converging output beam 411. When the object is moved towards the objective 406 to focal plane 430, the output will be a virtual image, resulting in a diverging output beam 413. In some embodiments, relay lenses 512 and 522 with an adjustable distance in between as shown in FIGS. 5A-5C can be used.

FIG. 5A is a side-view cross-sectional block diagram of a two-lens optical arrangement 501 that has an input beam 512 (such as beam 412 from objective 406 of FIG. 4) having parallel rays propagating along input optical axis 508 and an output beam 510 having parallel rays. In this configuration, lens 521 of relay-lens system 530 has a focus point 520 at distance 531 (the focal length of lens 521) for incoming parallel beam 512, and lens 522 has a focus point 523 at its focal length 532 to generate output beam 510 having parallel rays propagating along output optical axis 509. The total distance between lens 521 and lens 522 is distance 533, the sum of distance 531 and distance 532.

FIG. 5B is a side-view cross-sectional block diagram of a two-lens optical arrangement 502 that has an input beam 511 (such as beam 411 from objective 406 of FIG. 4) having convergent rays propagating along optical axis 508 and an output beam 510 having parallel rays. In this configuration, lens 521 has a focus point 520 at distance 531′ (shorter than the focal length of lens 521, which is defined for a parallel input beam as in FIG. 5A) for incoming convergent beam 511, and lens 522 again has a focus point 523 at its focal length 532 to generate output beam 510 having parallel rays propagating along output optical axis 509. The total distance between lens 521 and lens 522 is distance 534, the sum of distance 531′ and distance 532.

FIG. 5C is a side-view cross-sectional block diagram of a two-lens optical arrangement 503 that has an input beam 513 (such as beam 413 from objective 406 of FIG. 4) having divergent rays propagating along optical axis 508 and an output beam 510 having parallel rays. In this configuration, lens 521 has a focus point 520 at distance 531″ (longer than the focal length of lens 521) for incoming divergent beam 513, and lens 522 again has a focus point 523 at its focal length 532 to generate output beam 510 having parallel rays propagating along output optical axis 509. The total distance between lens 521 and lens 522 is distance 534, the sum of distance 531′ and distance 532.

As these beams 512, 511 or 513 enter relay-lens system 530, the focal distance of the first lens will be different. For the parallel input beam 512, the focal distance will be 531, which is the focal length of the first relay lens 521. On the other hand, the convergent beam 511 will produce a shorter focal distance, 531′, as shown in FIG. 5B. The divergent beam 513 will produce a longer focal distance, 531″, as shown in FIG. 5C. In order to have the focal point maintained at the same location 523 such that the relayed image of output beam 510 will be at the focus distance 532 of the second relay lens 522, the optical distances need to accommodate for the change in focal distances. These distance changes are usually done in some conventional systems by changing the focal length of lens 521 such that the location of the image remains at the same location 523, which is the focal length 532 of lens 522. A variable-focal-length lens is conventionally sometimes implemented using a liquid lens with a flexible membrane to make an electrically tunable liquid lens, such as described in U.S. Pat. No. 8,699,141, referenced above. With the pressure change in the liquid, the surface curvature can be changed, allowing the change in focal length. In such a liquid-lens focus-shift system, the lenses are remained fixed in position, however, the change in the liquid-lens shape of such conventional systems can introduce undesirable distortions and chromatic aberrations to the image.

Instead, in some embodiments of the present invention, the optical distance between the relay lenses is changed using the variable-path system described below.

Optical-Distance Adjustment with Retroreflectors

Adjusting the optical distance between two fixed objects such as lenses is usually achieved by linear movements of mirrors and/or lenses. Such linear-motion mechanisms usually involves motor, gears, linear translation slides, etc., which in combination, are usually quite heavy, which can limit the ultimate speed of motion of the system. In some embodiments of the present invention, a rotating-mirror system is used that includes a plurality of mirrors mounted onto a platform driven by a galvo-motor (also called galvanometer mirror) capable of high-speed reciprocal (oscillating) rotary motion, or, in other embodiments, are mounted onto a high-speed rotating platform that, in some such embodiments, rotates at a constant speed. In some such embodiments, the plurality of mirrors include one or more pairs of planar mirrors, mounted such that each pair of mirrors has its two mirrors mounted at right angles to one another such that an input optical beam incident to one of the two mirrors along an input optical axis reflects toward the other mirror and then is reflected along a first intermediate optical axis that is parallel to the input optical axis but in a direction opposite (i.e., antiparallel) to the direction of the input optical axis.

Galvo-Motor Reciprocal Rotating Retroreflector

In some embodiments, based on the special properties of a two-orthogonal-mirror (2-dimensional) retroreflector in which the output beam is antiparallel to the input beam but the spacing between the output beam and the input beam changes as the retroreflecting mirror pair rotates, two such orthogonal-mirror-pair retroreflectors facing one another provide the anti-parallel input-to-output beam function with the additional advantage that the output beam of two facing retroreflecting mirror pairs remains at the same fixed-in-position optical axis as one of the retroreflectors is rotated across a range of different angles.

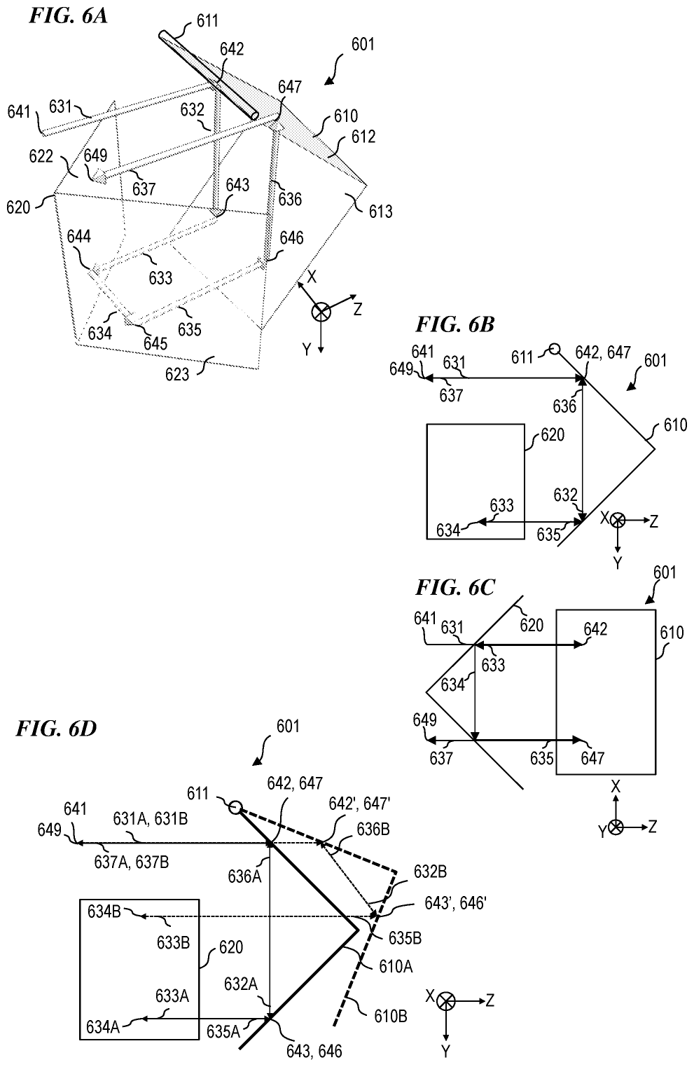

FIG. 6A is a perspective-view block diagram of a retroreflector optical-path-length-adjustment system 601 that uses a rotatable flat-mirror retroreflector 610 which rotates around axis 611 to change the optical-path length, and a fixed-position flat-mirror retroreflector 620, shown here with retroreflector 610 in a first rotational orientation of a plurality of possible rotational orientations around axis 611, according to some embodiments of the present invention. FIG. 6A shows the two orthogonal retroreflectors 610 and 620 together with the beam paths in which the input beam 631 is reflected back and forth between the two retroreflectors. If the angled axes of the retroreflectors are placed along the coordinate axes and the input beam is directed along one of the axes, all the reflected beams will be parallel to one of the axes and the output beam 637 will remain in a fixed location, parallel to input beam 631 and displaced to the side of input beam 631, and propagating in the opposite direction of the input beam 631. In some embodiments, retroreflector 610 rotates around rotational axis 611 to change the optical-path length and add a lateral displacement in a first direction (the Y-axis direction of first intermediate beam 632), between input beam 631 and second intermediate beam 633, then fixed-position flat-mirror retroreflector 620 retroreflects the intermediate beam 633 (via third intermediate beam 634) to be fourth intermediate beam 635 propagating in the antiparallel (opposite) Z-axis direction to intermediate beam 633, and adds a lateral displacement in a second direction (the positive X-axis direction of beam 634). In some embodiments, the lateral displacement in the second direction (from point 644 to point 645) is perpendicular to the variable-amount lateral displacement in the first direction (the positive Z direction from point 641 to point 642). After the intermediate beam 633 is reflected twice by fixed retroreflector 620 to form intermediate beam 635, retroreflector 610 then makes an additional change in the optical-path length and subtracts the same amount of lateral displacement in the first direction (the Y-axis amount of fifth intermediate beam 636) between intermediate beam 635 and output beam 637. Thus, output beam 637 remains in the same lateral position in the first and second directions regardless of the angle of rotatable retroreflector 610, but the total optical path length changes (the first total path length, with retroreflector 610 in a first rotational orientation, along the optical axis from a starting point 641, then successively to optical axis reflection points 642, 643, 644, 645, 646 and 647, directed finally to a finish point 649), with the path-length changes based on the angular orientation of retroreflector 610. (This is also shown in FIGS. 6B, 6C and 6D, versus the second total path length, with retroreflector 610 in a second rotational orientation, along the dashed-line segments 631B, 632B, 633B, 634B, 635B and 636B shown in FIG. 6D, again from starting point 641, then successively to points 642′, (the other reflections points of the dashed-line optical axis of optical-axis segments 631B, 632B, 633B, 634B, 635B and 636B are not labeled) then reflection point 646′ and finally to finish point 649, with the path-length changes based on the angular orientation of retroreflector 610. Because the angle of retroreflector 610 is continuously variable over a range of angles, the total path can be varied continuously over a selected range of lengths without changing the starting and finish points 641 and 649 and without changing the vector directions of input beam 631 or output beam 637.

FIG. 6B is a side-view cross-sectional block diagram of flat-mirror retroreflector optical-path-length-adjustment system 601 with retroreflector 610 in the first rotational orientation.

FIG. 6C is a top-view cross-sectional block diagram of retroreflector optical-path-length-adjustment system 601 with retroreflector 610 in the first rotational orientation.

FIG. 6D is a side-view cross-sectional block diagram of flat-mirror retroreflector optical-path-length-adjustment system 601 with retroreflector 610 in a first rotational orientation labeled 610A and in a second rotational orientation labeled 610B of the plurality of possible rotational orientations. When oscillating retroreflector 610 is in a first position labeled 610A, the input optical beam 631A along its optical axis is successively reflected to segments 632A, 633A, 634A (in the X direction, and thus not visible as a line in this view), 635A and 636A and then output as output beam 637A. When oscillating retroreflector 610 is in a second position labeled 610B, the input optical beam along axis 631B is successively reflected to segments 632B, 633B, 634B (in the X direction, and thus not visible as a line in this view), 635B and 636B and then output as output beam 637B which remains in the same vertical position and direction as retroreflector 610 is rotated from position 610A to 610B, displaced to the side of input optical beam 631 and remains in the same vector direction, antiparallel to input optical beam 631B along its optical axis.

One of the properties of this configuration is that when the rotating retroreflector that receives the input beam is rotated, the output beam will remain at the same optical axis while the optical path length from the input to the output is modified.

Continuing, FIG. 6D shows a side view of system 601 with the horizontal retroreflector 610 in two angular positions 610A and 610B rotated relative to one another. With the same input beam (labeled as 631A and 631B), the optical path lengths are different in the two angular positions 610A and 610B, but both beams incident on the vertical retroreflector 620 are reflected back to the horizontal reflector 610 at a new optical plane such that the output beam (labeled as 637A and 637B) will be parallel to the input beam 631A and 631B in the new optical plane. The optical-path-length difference per amount of angle rotated (sensitivity) can be changed by placing the axis of rotation 611 at a different location relative to the retroreflector 610. As a general rule, the further the axis of rotation is away from the center of mass of retroreflector 610, the larger will be the value for the sensitivity (change in optical-path length per amount of change of angle). Depending on needs of the system design, the axis-of-rotation location can be determined.

Retroreflector on Rotating Platform

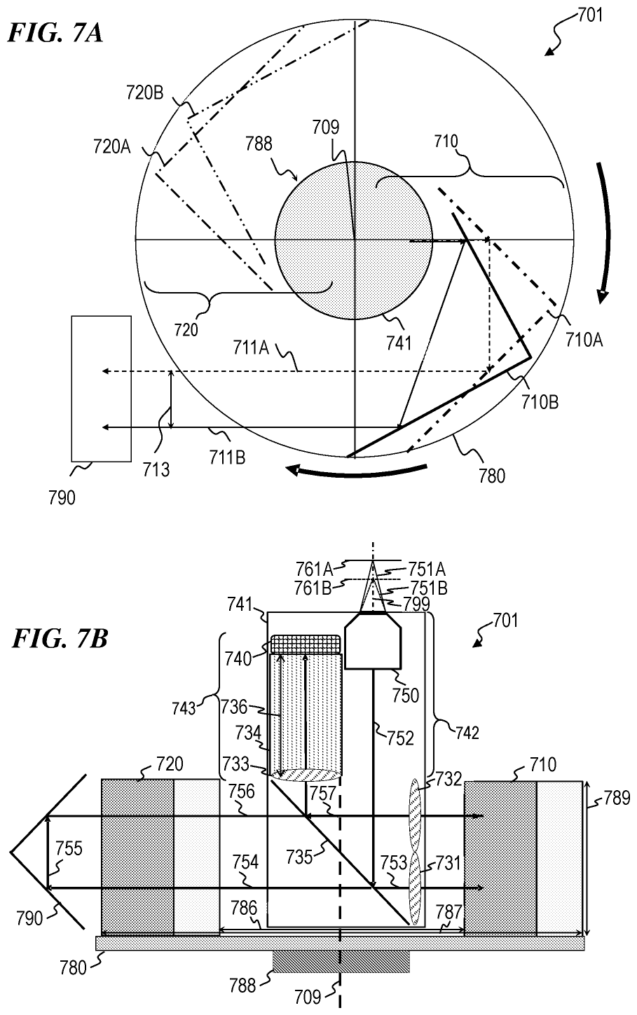

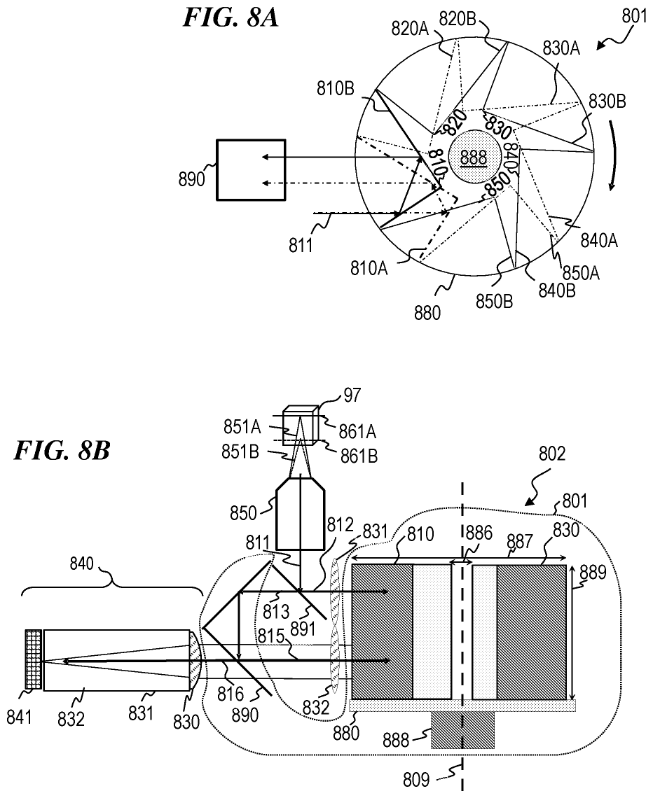

Another method providing the change in optical path, in some embodiments, is to place the retroreflector on a rotating platform as shown in FIG. 7A, FIG. 7B, FIG. 8A and FIG. 8B. In FIG. 7A, the microscope system is at the center of the rotating platform 780 and in FIG. 7B, the microscope system is at the outside of the rotating platform 780. In FIG. 7A, two positions of each of a pair of retroreflectors 710 and 720 are shown that are positioned opposite one another on rotating platform 780 (positions 710A and 710B being two rotational positions at two different moments in time of a first retroreflector 710, and positions 720A and 720B being two rotational positions at two different moments in time of a second retroreflector 720) with the rays shown for the 710A and 710B positions of retroreflector 710. As shown in FIG. 7A, FIG. 7B, FIG. 8A and FIG. 8B, in some embodiments, the axis of rotation is positioned far away from the center of mass of each retroreflector, making the sensitivity larger, while positioning a plurality of mirror-pair retroreflectors balanced around the rotational axis allows the center of mass of the rotating platform to be aligned to the rotational axis, for reduced vibration. In some embodiments, the fitting of a plurality of mirror-pair retroreflectors onto the same rotating platform makes the scan-repetition rate higher.

FIG. 7A is a top-view cross-sectional block diagram of a rotating retroreflector optical-path-length-adjustment system 701 with one or more retroreflectors, including retroreflector 710 shown in a first rotational orientation labeled 710A and in a second rotational orientation labeled 710B, according to some embodiments of the present invention. In some embodiments, system 701 includes a first retroreflector mirror pair 710 (shown in two rotational positions 710A (with thick dash-dot lines) and 710B (with thick solid lines, shown at a later time) as platform 780 rotates around axis 709) positioned to one side of rotational axis 709. In some embodiments, a second retroreflector mirror pair 720 (shown in two rotational positions 720A (with thin dash-dot lines) and 720B (with thin dash-dot-dot lines), as platform 780 rotates) positioned on the opposite side of rotational axis 709. As described below for FIG. 7B, in some embodiments, the microscope column 742, including microscope objective 750, and camera 743 and its imager 740, are located in stationary optical column 741 along rotational axis 709. In this top view, motor 788 (described in the description of FIG. 7B below) is below and hidden behind stationary optical column 741.

FIG. 7B is a side-view cross-sectional block diagram of rotating retroreflector optical-path-length-adjustment system 701. In some embodiments, as shown in the top view of FIG. 7A, system 701 includes a plurality of retroreflector mirror pairs rotating around rotational axis 709, including mirror pair 710 and mirror pair 720, both of which are affixed to platform 780. In some embodiments, platform 780 is rotated by motor 788, such that the plurality of retroreflector mirror pairs sweep out a circular rotational path having an outer circumference defined by diameter 787 and retroreflector height 789, and an inner circumference defined by diameter 786 and retroreflector height 789. In some embodiments, the stationary microscope column 742 (including microscope objective 750) and stationary camera 743 (including tube lens 733 having focal length 736, lens tube 734 and imager 740) are located above stationary 45-degree mirror 735 and relay lenses 731 and 732, which are located within the inner circumference of the round rotational path centered on or around rotational axis 709 and located between the plurality of retroreflector mirror pairs (e.g., 710 and 720 in the embodiment shown). In some embodiments, the focal plane moves between position 761A and 761B as the focal length changes (scans across a range of focal lengths) from 751A to 751B due to the optical path length changing as rotational platform 780 rotates. In some embodiments, imager 740 includes tube lens 733 having focal length 736, and lens tube 734 having a length and position configured such that the image from a given focal plane (of the continuous plurality of focal planes between 761A and 761B) is focused onto imager 740. In some embodiments, imager 740 is controlled to obtain a plurality of 2D images in sequence. In some such embodiments, the sequential images are combined using software, well-known to those of skill in the art, to generate a 3D representation of the object being imaged by combining the plurality of 2D images obtained at the different focal lengths. In some embodiments, retroreflector 720 provides a second scan of different focal planes of the object at a 180-degree rotation from the scan provided by retroreflector 710, such that two scans are performed for each rotation of platform 780. In some embodiments (not shown here), one or more additional retroreflectors are added and spaced around platform 780 to balance the center of rotational mass, such that three or more scans are performed for each rotation of platform 780. In some embodiments, system 701 uses an external stationary retroreflector 790 that allows scanning across a range 713 of beam positions (see FIG. 7A).

In some embodiments, vertical retroreflector 790, which is fixed in position, is outside the rotating platform 780 (i.e., outside the outer circumference of the rotational path of the rotating plurality of retroreflector mirror pairs). Part or all of the optics are placed inside the stationary optical column 741, which is between the rotating horizontal retroreflectors 710 and 720 but not attached to rotating platform 780. Using a planar mirror 735 at an angle, the image beam 752 of the sample projected by the objective lens 750 is reflected outwards as beam 753 towards the horizontal retroreflector (retroreflector 710, in the position of the system portrayed in FIG. 7B). The retroreflected beam 754, which is antiparallel to beam 753 and displaced horizontally from it, is then directed towards the fixed vertical retroreflector 790, where the reflected beam 755 is directed vertically to the top half of the system and reflected back as beam 756 to horizontal retroreflector 710, where it is retroflected as output beam 757 that is antiparallel to, and horizontally displaced from, beam 756. The output beam 757 from horizontal retroreflector 710 is then reflected by fixed mirror 735 and directed upward through tube lens 733 towards the CCD camera imager 740. Since the CCD camera system 743 and the objective 750 are fixed, in some embodiments these components are configured differently, with additional planar mirrors, depending on the physical requirements outside the rotating platform and optics.

FIG. 8A is a top-view cross-sectional block diagram of a rotating retroreflector optical-path-length-adjustment system 801 with a first retroreflector 810 in a first rotational orientation labeled 810A and in a second rotational orientation labeled 810B, according to some embodiments of the present invention. In some embodiments, system 801 includes a motor 888 that rotates rotational platform 880 that includes a plurality of retroreflectors, each substantially similar to retroreflector 810 (in the embodiment shown, five retroreflectors 810, 820, 830, 840 and 850) each shown here in two positions (rotational positions 810A, 820A, 830A, 840A and 850A at a first point in time and further rotated positions 810B, 820B, 830B, 840B and 850B at a later second point in time) of a plurality of continuously variable angular positions. In some embodiments, system 801 uses an external stationary retroreflector 890 that allows scanning across a range of beam positions.

Electrically Tunable Focus Shift using Rotating-Platform-Driven Retroreflectors

FIG. 8B is a side-view cross-sectional block diagram of a microscope imaging system 802 that uses a rotating retroreflector optical-path-length-adjustment system 801, according to some embodiments of the present invention. In some embodiments, platform 880 is rotated by motor 888, such that the plurality of retroreflector mirror pairs sweep out a rotational path having an outer circumference defined by outer diameter 887 and retroreflector height 889, and an inner circumference defined by diameter 886 and retroreflector height 889. In some embodiments, the vertical retroreflector 890, which is fixed in position, is outside the rotating platform 880. All the optics for the microscope system 802 are placed outside the rotation platform 880 and its retroreflectors 810, 820, 830, 840 and 850 (see FIG. 8A). Using a planar input-reflector mirror 891 at an angle, the image 811 of the sample 97 projected by the objective lens 850 is reflected towards horizontal retroreflector 810. The antiparallel, horizontally displaced retroreflected beam 813 is then directed towards the fixed vertical retroreflector 890 where the beam is reflected vertically to the bottom half of the system, with beam 815 propagating back to the horizontal retroreflector 810, where it is retroflected as output beam 816 that is antiparallel to, and horizontally displaced from, beam 815. The output beam 816 from the horizontal retroreflector 810 is then directed towards the CCD camera 840. In some embodiments, CCD camera 840 includes tube lens 830 that has focal length 832, lens tube 831, and imager 841. In FIG. 8B the CCD camera system 840 and the objective 850 are positioned at fixed locations, as shown. In some other embodiments, these components are configured differently, such as orienting them differently with one or more additional planar mirrors, depending on the physical requirements outside the rotating platform and optics.

Electrically Tunable Focus Shift using Galvo-Motor-Driven Retroreflectors

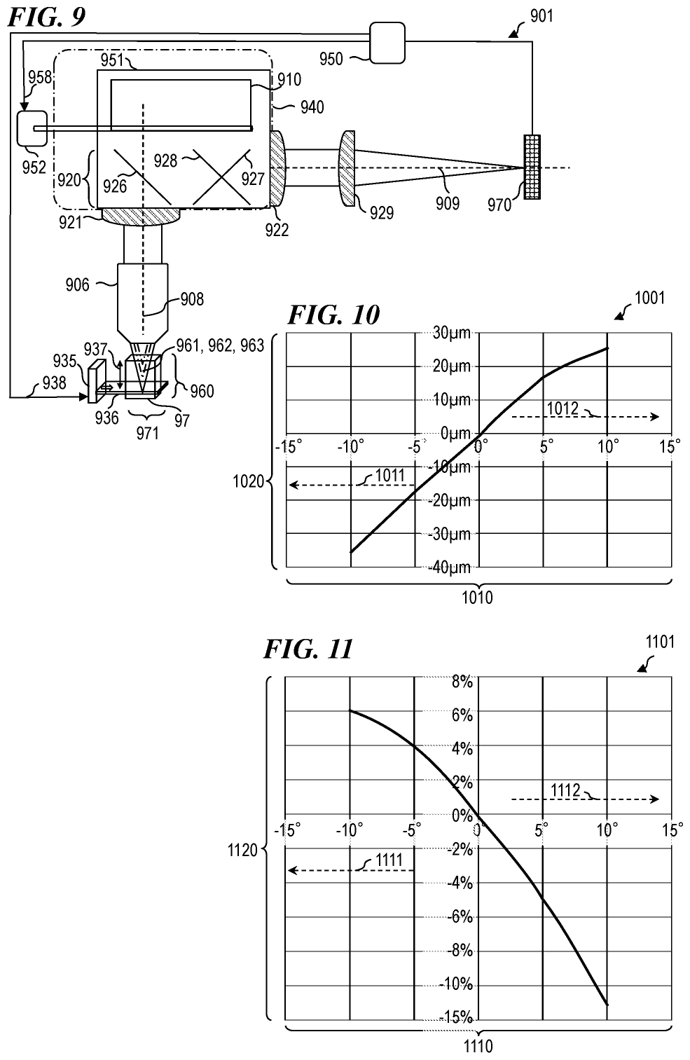

To implement an electrically tunable galvo-motor driven retroreflector focus-shift system using relay lenses, in some embodiments, optical-path-length module 940 as shown in FIG. 9 is used in the gap between the relay lenses 921 and 922. FIG. 9 shows a block diagram of the system in which a prototype has been made for demonstration.

FIG. 9 is a side-view cross-sectional block diagram of a right-angle microscope imaging system 901 that uses an oscillating retroreflector optical-path-length-adjustment system 940, according to some embodiments of the present invention. In some embodiments, system 901 includes a variable-optical-path-length relay-lens subsystem 940 that includes a fixed three-mirror system 920 (mirrors 926, 927 and 928) and a rotatable retroreflector 910 between a first relay lens 921 and a second relay lens 922. The fixed retro-reflector is formed by reflectors 926 and 927, and the output beam is reflected rightward by mirror 928 to exit through lens 922. In some embodiments, system 901 also includes objective lens 906 that gathers light from a range 960 of focal distances (e.g., focal distances 961, 962, . . . 963 to obtain images at various focal planes) within the volume of object 97, and tube lens 929 (or other suitable focusing optics) that focuses an image on camera imager 970, according to some embodiments of the present invention. The relay lenses 921 and 922 form the input and output relay lenses of system module 940 (which, in various embodiments, is implemented using a suitable modification of any of the other above-described optical-path-adjustment mechanisms and/or methods). In some embodiments, module 940 is inserted into a conventional microscope system with its objective lens 906 and input optical axis 908 at right angles to output optical axis 909 and its tube lens 929, and its imager 970. As the focus plane at distances 961, 962, . . . 963 is moved along object 97 within focal-shift range 960, the optical-path length is adjusted accordingly inside the optical-path-length relay-lens subsystem 940 such that the image on the CCD 970 corresponding to the desired focus plane remains in focus. In some embodiments, a plurality of images is obtained corresponding to a corresponding plurality of focal planes within object 97, and each image of the plurality of images is recorded along with an indication of the location of the respective focal plane, and software well known in the art is used to construct a 3D representation of the object within the imaging volume 97; that is, object 97 remains in a fixed position and the focal plane is adjusted to obtain cross-sectional images at different depths in object 97.

In some embodiments, an optional source 935 of light-sheet illumination (such as fluorescence-excitation light, e.g., for fluorescent microscopes) is provided. In some such embodiments, light-sheet illumination source 935 outputs a scanned light sheet 936 or other “slice” illumination (e.g., 405-nm light from a violet laser that causes fluorescent emission in certain objects or fluorescent-tagged portions of objects) that is scanned across a range 937 of light-sheet positions, which forms an excitation-light-sheet beam, that is moved in synchrony with adjustments to the focal plane. In some such embodiments, the excitation light sheet 936 is pulsed (either on-off, or to output one of a range of different excitation wavelengths in different sequential pulses) and a plurality of images is obtained at the same location or locations very close to one another, such that one image is obtained at each focal plane with a particular wavelength excitation light and (in embodiments outputting one of a range of different wavelengths in different pulses) one or more other images are obtained with other wavelengths of illumination at each focal plane.

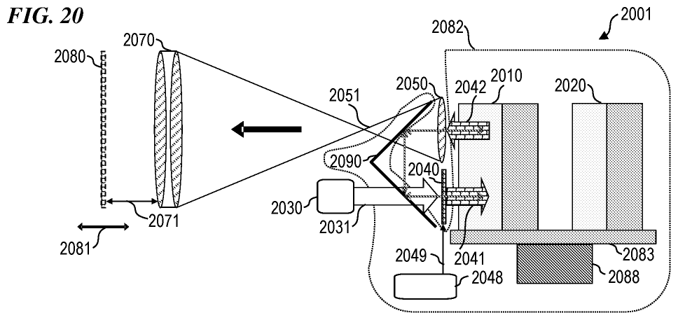

In some embodiments, light-sheet illumination source 935 is combined with any other of the microscope systems described herein. In some embodiments, a version of controller 950 is used to control and synchronize image-acquisition timing, focal-plane position (focal length), and light-sheet position of such systems to obtain a plurality of 2D images and corresponding focal-plane positions, such that the resulting 3D representation of the object can be viewed, for example, by a floating-image display system such as system 2001 of FIG. 20 described below.

In some embodiments, such as system 901, the orthogonal retroreflectors 910 and 920 are housed inside the mirror module (optical-path-length module 940 that includes housing 951) in which retroreflector 910 is driven by signal 958 from controller 950 to various angles using high-speed galvo-motor 952. The first relay lens 921 and second relay lens 922 are placed on housing 951 at the input and output ports of the module 940. As galvo-motor 952 rotates retroreflector 910, the location of the scanned focus (961, 962, 963) of objective 906 will be shifted accordingly, with the focused image cast onto the CCD camera imager 970. In some embodiments, data indicating the location of the scanned focus is recorded in computer memory (not shown) along with the corresponding image data, and optionally data regarding the light sheet 936 that was ON for the respective image.

As shown in FIG. 9, the volume 97 inside the 3D sample 971 within the focus-shift range 960 can be imaged by system 901 by changing the rotational angle of the galvo-motor 952. The system controller 950 performs the function of controlling the galvo-motor 952 and 2D image acquisition by the CCD camera imager 970. By combining the 2D image from the CCD camera imager 970 together with the third dimension from the focus-shift location, a full 3D volumetric information of the sample is obtained. Using an appropriate 3D viewing software, the 3D volumetric image can be displayed and visualized. While the CCD camera imager 970 can have a speed of data capture suitable for real-time image acquisition, the focus-shift system has to have synchronized high-speed responses of its elements.

Mechanical systems that adjust focus by moving lenses or the sample to be imaged, as mentioned before, are slow in movement and would not provide smooth real-time moving images. Electrically tunable lenses (such as described in U.S. Pat. No. 8,699,141) involve flexible curved lens surfaces that may distort the image.

In contrast, the present invention with its planar-mirror-based systems using a high-speed galvo-motor (such as shown in FIGS. 6A, 6B, 6C, 6D, 9, 13, and 14) or a rotating platform (such as shown in FIGS. 7A, 7B, 8A, 8B, 15, 16, 18 and 20), provide focal-shift speed matched to the speed of the CCD camera, allowing smooth real-time motion pictures of the 3D sample. With an advanced microscope system using optional scanning light-sheet illuminator 935 such as shown in FIG. 9, in some embodiments, system controller 950 also provides a synchronization signal 938 to the scanning-light-sheet illuminator 935 such that the location of the light sheet 936 corresponds to the location of the focus at that particular instant of time. Such a light-sheet illumination system allows an increase in vertical resolution by illuminating only the very thin focal plane for imaging. In addition, since the sample is illuminated using a scanning light sheet, the total optical energy absorbed by the sample 97 (which, at high intensity, duration and/or energy, will cause undesirable bleaching or heating of certain samples) will be much lower, with minimal disturbance to the sample and avoiding possible destruction of the sample.

Experimental Results and Issues with Changing Magnifications

An experiment was performed with a prototype built substantially as shown in FIG. 9, except that galvo-motor 952 was replaced by a manual rotational stage in order to make initial measurements of focus-shift amounts versus angle and magnification versus angles. In this experiment, the nominal distances were set based on the focal lengths of the objective lens 906 and the relay lenses 921 and 922. With this initial condition, the object was placed at the focal point of objective 906, the image is formed at infinity and captured by the CCD camera imager 970 using tube lens 929 and the predetermined lens tube with its length equal to the focal length of tube lens 929. The object used was the pixels of an iPhone screen, which has small dimensions and emits light, making further illumination of the sample object unnecessary. The focus shift is performed by moving the iPhone screen up and down using a vertical-translation stage with micrometer adjustments. The screen was moved by a predetermined amount and the rotational stage was turned such that the image from imager 970 was in focus again. Both the focal shift distance and the rotational angle were recorded. The results are shown in the graphs of FIG. 10 and FIG. 11.

FIG. 10 is a graph 1001 of focus shift versus rotational angle for one type of microscope imaging system, according to some embodiments of the present invention. Graph 1001 shows the dependence of focus shift 1020 versus the angle of rotation 1010 (with degree change 1011 being closer to the objective and change 1012 being away from the objective). Graph 1001 shows that with a total change of 20 degrees, a focus shift of 60 μm can be achieved. This system uses a 40× objective, and relay lenses with 100 mm and 125 mm focal lengths. The tube lens 929 had a focal length of 200 mm and a CMOS camera was used for imaging device 970.

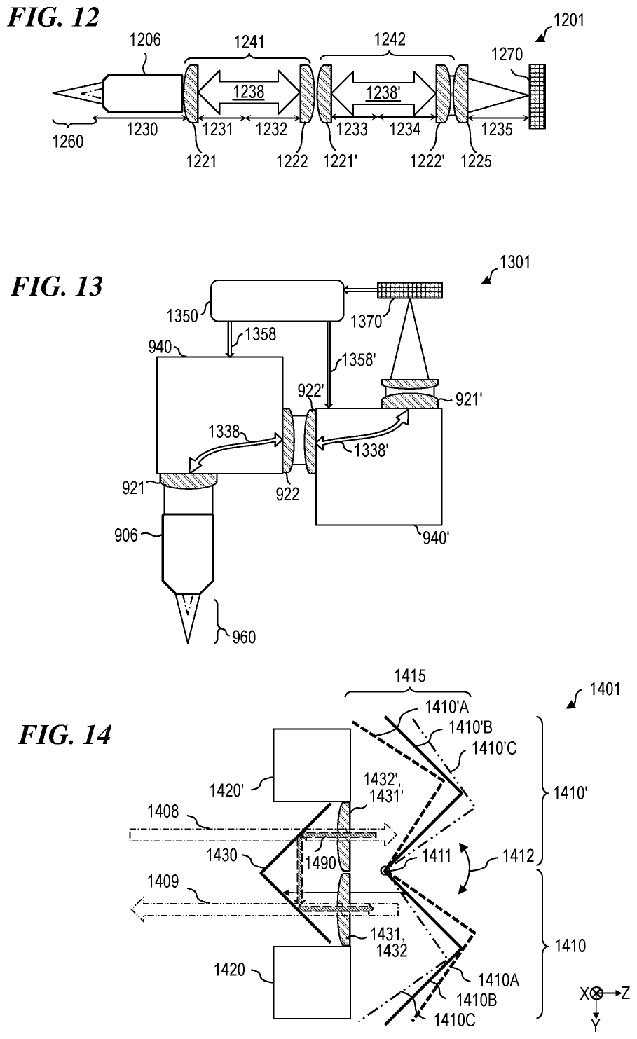

FIG. 11 is a graph 1101 of magnification versus rotational angle for one type of microscope imaging system, according to some embodiments of the present invention. Graph 1101 shows the relative magnification 1120 of the system versus the angle of rotation 1110 (with degree change 1111 being closer to the objective and change 1012 being away from the objective). Graph 1101 shows that magnification changes with angle. Magnification changes with angle are not desirable, but using digital techniques, sometimes the displayed images can be corrected and made to have the same magnification. In some embodiments of the present invention described below and shown in FIGS. 12-16, the present invention provides compensating optical solutions to help maintain constant magnification as the optical path length is varied.

Constant Magnification Using Dual-Relay with Retroreflectors

Although the changing magnification can be corrected digitally, it would be desirable to have a system that can have focus shift with constant magnification. FIG. 12 shows the schematic diagram of the microscope system 1201 with two relay-lens sections.

FIG. 12 is a side-view cross-sectional block diagram of a microscope imaging system 1201 that uses two optical-path-length-adjustment systems 1210 and 1220, according to some embodiments of the present invention.

When the optical path length of each section is controlled and synchronized, the first relay's (optical-path-length-adjustment system 1241's) magnification together with the second relay's (optical-path-length-adjustment system 1242's) magnification will cancel each other's output, producing a constant magnification. A simple way to achieve this is to use two variable-path-length systems, as shown in FIG. 12, with synchronized control of each relay-lens section by the system controller (not shown). The relationship of the path lengths can be determined and uploaded to the controller. An experiment using the FIG. 12 description is discussed in more detail, further below.

Dual-Relay with Scanning Retroreflectors

FIG. 13 is a side-view cross-sectional block diagram of yet another microscope imaging system 1301 that uses two retroreflector optical-path-length-adjustment systems 940 and 940′, according to some embodiments of the present invention. In some embodiments, dual-relay microscope system 1301 uses two scanning system modules 940 and 940′ (each substantially similar to modules 940 shown in FIG. 9 and described above), positioned as shown. A system controller (not shown) is used to control the two scanning-retroreflector system modules such that a magnification change in one module is compensated by an opposite magnification change in the other module, and to control acquisition of the two-dimensional (2D)images from the CCD camera 1370. The plurality of images and the corresponding location of the focus for each image are synchronized, producing a 3D image of the object. In some embodiments, the present invention uses a floating-image display device such as shown in FIG. 20 to output a visual 3D representation of the object.

FIG. 14 is a side-view cross-sectional block diagram of an optical-path-length-adjustment imaging system 1401 that uses two coupled side-by-side oscillatory retroreflectors 1410 and 1410′ that use a single shared oscillatory rotational stage 1415, according to some embodiments of the present invention.

In some embodiments, the two scanning retroreflectors 1410 and 1410′ are connected to the same axis of rotation 1411 such that change of angle for retroreflector 1410 results in the opposite change of angle for retroreflector 1410′. The output 1408 from the objective lens (not shown) enters the first relay-lens system through relay lens 1431′, passes through orthogonal retroreflector system 1410′ and 1420′ and exits the first relay-lens system through relay lens 1432′ (underneath relay lens 1431′) as parallel beam 1490 displaced below beam 1408. As shown in FIG. 14, the two lenses 1431′ and 1432′ of the first relay-lens system are at different planes, on top of each other. The output 1490 from this first relay-lens system is then retroreflected by the retroreflector 1430 as shown such that the direction is changed and it becomes the input to the horizontal retroreflector 1410. Similarly, after reflections through this second orthogonal retroreflector system, in some embodiments, the output 1409 is directed towards a CCD camera (not shown).

As described earlier, the optical-path lengths of the two relay-lens systems are not the same and change synchronously at different rates, thus compensating for each other's change and maintaining a constant magnification. As a result, the two horizontal retroreflectors 1410′ and 1410 are scanning at the same angular scanning rate, but at different optical-path-length-change rates. In some other embodiments, this differential rate-change is achieved by moving the axis of rotation 1411 away from the symmetrical position shown in FIG. 14, to an offset location, such that the required differential path-length change rate is obtained with the same angular scanning rate.

Dual Relay with Single-Axis Dual Rotating Platforms

Some embodiments of the rotating-platform-with-retroreflector system provide a dual-relay-lens system that allows constant magnification to be achieved.

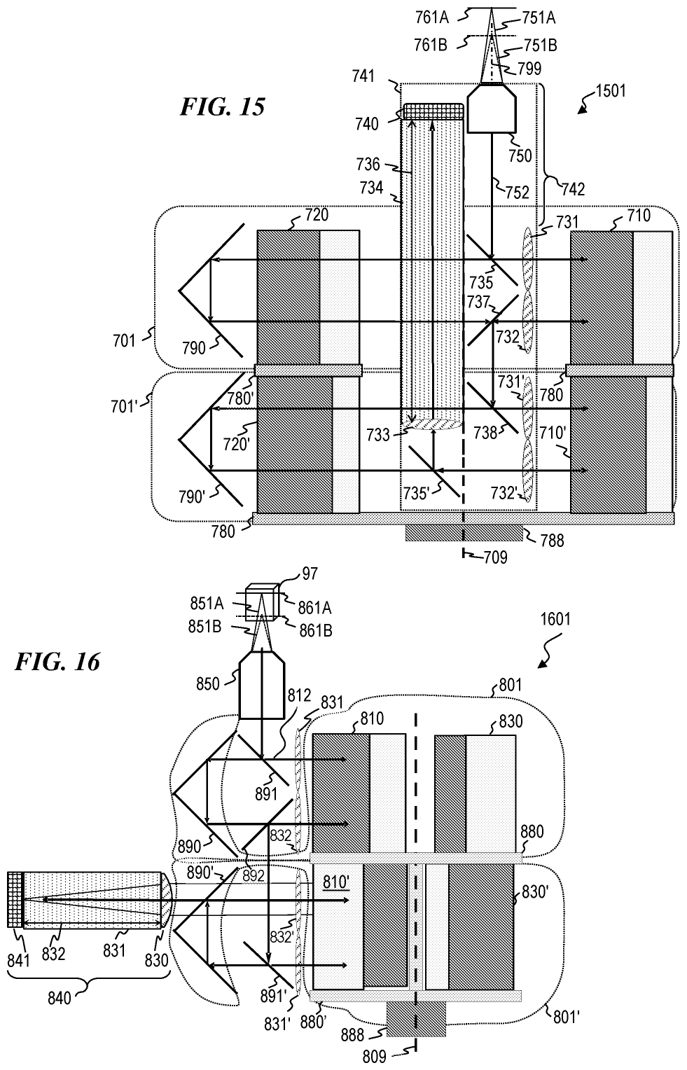

FIG. 15 is a side-view cross-sectional block diagram of yet another microscope imaging system 1501 that uses two rotating optical-path-length-adjustment systems 710 and 710′ that use a single shared motor 788 driving stacked rotating rotational platforms 780 and 780′ and having relay lenses 731, 732, 731′, and 732′ inside the inner circumference of the rotational path of the rotating retroreflectors 710, 720, 710′, and 720′, according to some embodiments of the present invention. In some embodiments, system 1501 uses a dual-rotating-platform system with a single motor 788 and single axis of rotation 709, with the configuration of each platform similar to that shown in FIG. 7B described above. A set of rotating components as shown in FIG. 7B is duplicated, and put on top of the original set, forming two rotating platforms with horizontal retroreflectors. The output from one platform is transferred to the other platform using two 45-degree mirrors 737 and 738, as shown. The components in the optical column 741 are modified, as shown, with two sets of relay lenses 731, 732, 731′, and 732′. As discussed earlier, the two relay-lens systems have different sensitivities (i.e., mm/degree as discussed previously), such that the magnification of one is compensated by the other, providing a constant magnification. This difference in sensitivity can be designed by orientating the horizontal retroreflectors 710 and 710′ differently (e.g., in some embodiments, by placing retroreflectors 710 and 710′ at different angular positions and/or orientations on the platforms 780 and 780′). Also shown in FIG. 15 are optical-path-length-adjustment systems 720 and 720′ that are located opposite to optical-path-length-adjustment systems 710 and 710′ on stacked rotational platforms 780 and 780′. As rotational platforms 780 and 780′ rotate 180 degrees from the position shown in FIG. 15, the optics of optical-path-length-adjustment systems 720 and 720′ are engaged to receive sample image beam 752 from objective 750, and deliver a focused image to CCD camera imager 740 such that two scanned images are obtained by imager 740 for each rotational revolution of platform 780.

FIG. 16 is a side-view cross-sectional block diagram of still another microscope imaging system 1601 that uses two rotating optical-path-length-adjustment systems 801 and 801′ that together use a single motor 888 driving stacked rotating rotational systems 801 and 801′ having relay lenses 831, 832, 831′, and 832′, microscope objective lens 850, and the image acquisition system 840 outside the rotating sets of mirrors of systems 801 and 801′, according to some embodiments of the present invention. In some embodiments, system 1601 includes a dual-rotating-platform system with a single motor 888 and single axis of rotation 809, with the configuration of each platform of optical-path-length-adjustment systems 801 and 801′ being similar to that shown in FIG. 8B. A set of rotating and stationary components of system 801 as shown in FIG. 8B is duplicated (801 being one copy and 801′ being the second copy), and put one on top of the other, forming two coupled rotating platforms with rotating horizontal retroreflectors (810, 810′, 830, 830′). Using the upper input reflector 891 (in some embodiments, a planar mirror) at an angle, the image 811 of the sample 97 projected by the objective lens 850 is reflected towards horizontal retroreflector 810. The output from one system (801) is transferred to the other system (801′) using the upper output reflector 892 and lower input reflector 891′, as shown. The components in the stationary optics are modified, as shown, with two sets of relay lenses (831, 832 and 831′, 832′). As discussed earlier, in some embodiments, the two relay-lens systems have different sensitivities (i.e., mm/degree, as discussed previously), such that the magnification of one relay-lens system is compensated by an opposite magnification in the other relay-lens system, providing a constant magnification. In some embodiments, this difference in sensitivity is designed by orientating the horizontal retroreflectors 810 and 810′ differently on their respective platforms 880 and 880′ (e.g., in some embodiments, by placing retroreflectors 810 and 810′ at different angular positions and/or orientations on the platforms 880 and 880′).

Calculations and Experimental Results

In an experiment, a benchtop system was set up with the configuration as shown in FIG. 12. In this experiment, the objective lens is a Nikon NIR Apo 40X/0.8w, the first relay-lens system 1241 of lenses 1221 and 1222 uses 100-mm and 125-mm focal-length achromatic lenses. The second relay-lens system 1242 of lenses 1221′ and 1222′ uses 100-mm and 150-mm focal-length achromatic lenses. In the nominal configuration, the distances (distance 1231 plus distance 1232, and distance 1233 plus distance 1234) between the lenses are 225 mm and 250 mm for the respective relay-lens systems. The imaging system uses a 200-mm-focal-length achromatic lens 1225 and a 200-mm lens tube (not shown), together with a CMOS camera imaging device 1270. The initial adjustment is to move the sample, which (for this test) are the screen pixels of an iPhone that are moved by moving the iPhone. The sample position (the location of the iPhone) is adjusted in the axial direction such that a sharp, focused image is obtained. This defines the baseline image and magnification of 100%.

An Excel spreadsheet was set up using the lens formula, transferring the image of the sample at a certain distance from the objective lens, through the objective lens 1206, relay-lens group 1241's relay lens 1221 (refer to FIG. 12), relay-lens group 1241's relay lens 1222, and relay-lens group 1242's lens 1221′. To allow a focused image to be detected by system 1201, the output from lens 1221′ has to fall at the focal point of lens 1222′ such that the output of lens 1222′ is a parallel beam for imaging by the tube lens 1225. An additional parameter is to have a constant magnification of 100%, which requires optimization of certain parameters of system 1201. As shown in FIG. 12, with a certain focus-shift distance 1230, distance 1231 is calculated. Distance 1232 and distance 1233 are to be optimized such that 100% magnification is obtained at the focus of lens 1222′. This can be done using the “Solver” tool available in Excel by setting the magnification and varying distance 1232 and distance 1233. The final output of the optimization provides the optical path in relay-lens group 1241, which is distance 1231 plus distance 1232, and in relay-lens group 1242, which is distance 1233 plus focal length 1234.

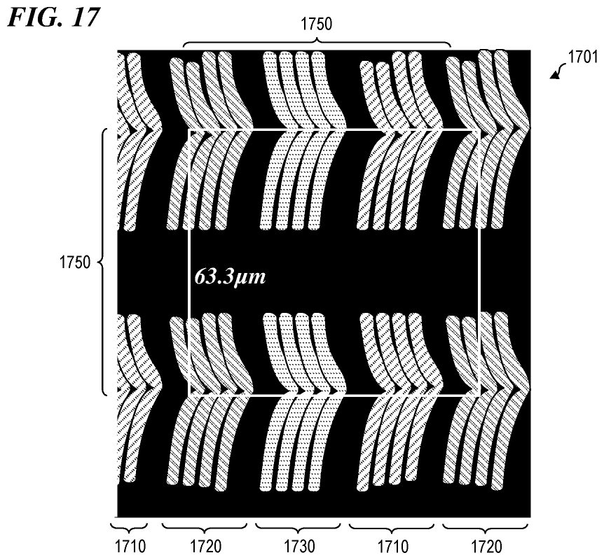

FIG. 17 is a drawing 1701 of a photomicrograph that showed an image of iPhone pixels used in experiments, demonstrating results of optimization and measured results. Table 1 shows the results of such optimization and measured results. Three repeated red-blue-green colors—1710, 1720, and 1730, respectively—are seen, with a 63.3 μm unit-cell pixel 1750.

TABLE 1

| | At Working Distance | | | | |
|---|---|---|---|---|---|
| Focus Shift (μm) | −20 | −10 | 0 | 10 | 20 |
| Relay Lens 1 (mm) | 240.03 | 232.2 | 225 | 218.35 | 212.19 |
| Relay Lens 2 (mm) | 246.28 | 248.14 | 250 | 251.87 | 253.74 |
| Measured Magnification | 100% | 100% | 100% | 100% | 100% |

In this calculation, the sample was set to move from −20 μm to +20 μm. The relay-lens-1 and relay-lens-2 distance values were non-absolute and show the amount of deviations from the nominal locations 225 mm and 250 mm of the lenses and were set to the optimized spacing as listed. The focused image of each case was recorded as shown in Table 1. Experiments were also performed and the distances were recorded. It was shown that upon aligning the system with the calculated parameters, the measured magnifications are also constant, as expected by using the present invention.

System Implementation

The present invention provides a method for operating a basic focus-shift system such as system 901 shown in FIG. 9. In some embodiments, the method includes repeatedly performing a 2D image frame acquisition by the CMOS camera 970, and detecting the corresponding angle of scanning retroreflector 910. As the 2D camera frame images are captured at the plurality of focal planes, the corresponding angular positions of the retroreflector 910 are also recorded at the same time. Based on the angular position, in some embodiments, the optical path length is determined by calculation using a suitable formula or by table look-up. With this optical-path length data, the location of the focal plane of the corresponding image (its focus shift) is determined and is optionally used in the generation of the 3D representation of the sample object from the 2D images.

In some embodiments of this system that use light-sheet illumination, the system controller 950 issues a command via signal 938 to the light-sheet illuminator 935 based on the focus-shift value, in order that the light-sheet illuminator 937 moves the light sheet 936 to the location of the image plane, such that the image plane is illuminated.

In some embodiments, light sheet 936 is produced using standard lenses forming a Gaussian beam in two dimensions, which becomes light sheet 936. Due to the properties of Gaussian beams and optics, the thickness of the light sheet determines the width of the light sheet. The thinner the sheet, the less-wide is the thin region. In some embodiments, with special Bessel-beam optics well known to those of skill in the art, a Bessel beam is generated in which the thickness is made thin while having a much larger width than is available using a Gaussian beam, allowing the illumination of a larger field of view.

High-Speed Volumetric Display using Rotating Retroreflectors

As shown in FIG. 20, some embodiments of the present invention use one or more rotating retroreflectors 2010 and/or 2020 and an orthogonally positioned stationary retroreflector 2090, and the optical path can be changed at a high speed. Together with a floating-image optical arrangement, the image from the stationary display panel 2040 is viewed as an axially moving floating image 2080 (moving along direction 2081). Using sliced 2D images from a 3D representation of an object (such as, for example, images obtained using any of the systems described above), a volumetric image is formed as a floating image seen by the human viewer. FIG. 20 is discussed further, below.

Volumetric displays are becoming more important as imaging and computing power have increased many-fold in the last decade. Now it becomes possible to capture or create digitally 3D images in almost any field of expertise, e.g., medical, biological research, mechanical designs, etc. It has been a tremendous challenge for such images to be displayed and especially at low cost, which would be the prime criteria for the technology to penetrate into the mass market. The present invention, as described herein, provides a simple and low-cost method for creating such a 3D floating image in space using a standard LCD display and a rotating retroreflector together with an orthogonal stationary retroreflector.

In some embodiments, the basic structure of the optical-path-length-adjustment system is based on two orthogonal retroreflectors as shown in FIG. 6A, described above. The input beam 631 is directed at the mirror 612 of the horizontal retroreflector 610, reflected down (beam 632) to mirror 613, then reflected (as beam 633) towards mirror 622 in the same vertical plane of the input beam 631. The beam is then reflected (as beam 634) by this stationary retroreflector 620 from mirror 622 to mirror 623, then reflected (as beam 635) by mirror 623, and reflected (as beam 636) by mirror 613, finally outputting a beam 637 antiparallel (laterally displaced and propagating in a direction opposite) to the input beam 631. As the horizontal retroreflector 610 is rotated, the vector directions of the beams remain the same except that the beams' incident location onto the vertical retroreflector 620 will be moving up and down on the mirror surfaces 622 and 623. After all the reflections, the output beam remains at the same fixed-in-position optical axis. However, due to the change in optical paths, the total optical path length is changed. This change in optical path length with rotation angle forms the basic building block of the high-speed volumetric display system 2001.

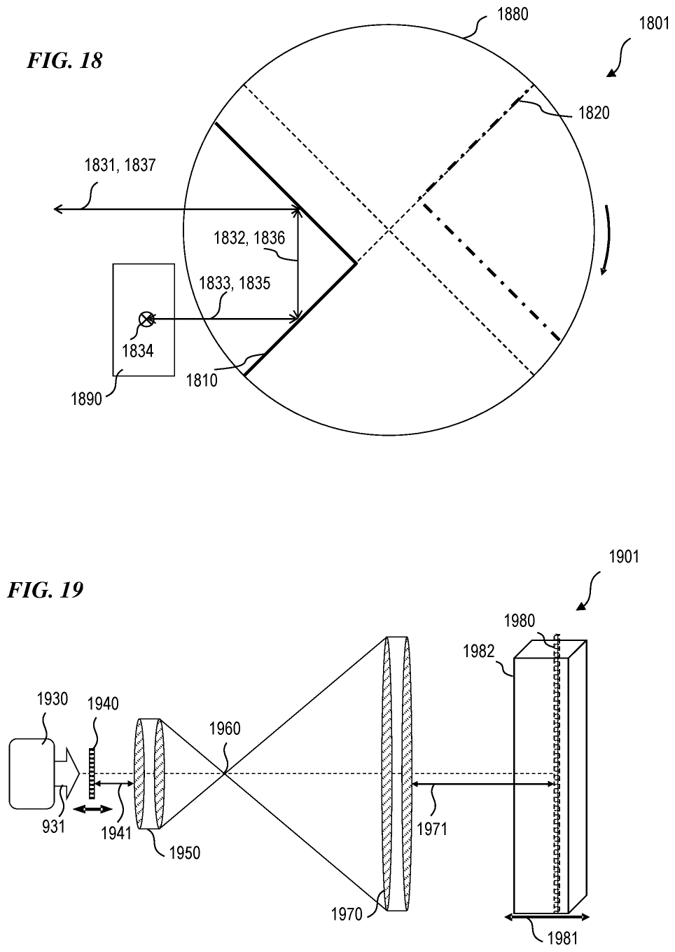

FIG. 18 is a side-view cross-sectional block diagram of an optical-path-length changing subsystem 1801 having a changeable optical-path length that uses a rotating platform 1880 having one or more retroreflecting sets of mirrors, such as retroreflecting mirrors 1810 (and optionally retroreflecting mirrors 1820 and, in some embodiments, additional others), according to some embodiments of the present invention. In some embodiments, subsystem 1801 forms a rotating retroreflector for the 3D display of FIG. 20, wherein the horizontal retroreflector 1810 is mounted on a rotating platform 1880. In some embodiments, a plurality of such retroreflectors 1810 . . . 1830 are mounted so as to balance the rotation and increase the scan repetition rate of the system, since each time one of the plurality of horizontal retroreflectors passes the input beam, it creates a complete scan of the range of optical-path-length changes, which corresponds to a complete volume 1982 of floating images 1980 as described in FIG. 19.

FIG. 19 is a side-view cross-sectional block diagram of an imaging system 1901 having a changeable optical-path length that generates a floating image 1990, according to some embodiments of the present invention. FIG. 19 shows a configuration of a basic optical system 1901, wherein the image of the LCD panel 1940 is transferred to the output as a 3D image (1980) that appears to a human as “floating in air.” As the location of LCD panel 1940 is moved left-to-right and back, distance 1941 (D1) is varying, such that distance 1971 (D3) also varies, so the location of the real floating image 1980 also changes accordingly. Table 2 shows the relationship between D1 (distance 1941) and D2 (distance 1971) for an example system with magnification.

TABLE 2
Relationship between Distances and Magnification

| | | | | | |
|---|---|---|---|---|---|
| Distance D1 (mm) | 102 | 101 | 100 | 99 | 98 |
| Distance D2 (mm) | 450 | 475 | 500 | 525 | 550 |
| Magnification | 4.41 | 4.70 | 5.00 | 5.30 | 5.61 |

For a system with the focal lengths of the first and second lens being 100 mm and 500 mm respectively, when the distance D1 change from 98 mm to 102 mm (a total of 4 mm), the output floating image location changes from 450 mm to 550 mm (a total of 100 mm). At the same time, the magnification changes from 4.41 to 5.61. If the input images are not corrected, the output displayed volume will be a trapezoid. With the high-speed image processing technologies available, in some embodiments, the size of the image is scaled accordingly in synchronism with the distance D1 such that constant magnifications are obtained. In other embodiments, one of the constant-magnification systems described above (see, e.g., systems 1301, 1401, 1501, or 1601) is used in system 2001 of FIG. 20.

Although FIG. 19 is shown with two lens pairs, wherein the second lens pair is the larger of the two lens pairs, in some other embodiments, the first lens pair and/or the second lens pair is replaced by concave reflectors or combinations of concave and convex reflectors or other focusing optical elements. In general, one or both lens pairs can be replaced by reflectors, as may be required, based on desired imaging quality, cost, space, etc.

FIG. 20 shows one embodiment of the actual system 2001, as designed and fabricated for demonstration.

FIG. 20 is a side-view cross-sectional block diagram of an imaging subsystem 2001 having a changeable optical-path length that, when combined with focusing optics such as shown in FIG. 19, generates a floating image 2080, according to some embodiments of the present invention. In some embodiments, subsystem 2001 includes a rotating retroreflector optical-path-length-adjustment system 2082 that includes stationary retroreflector 2090 and two rotating horizontal retroreflectors 2010 and 2020, wherein the number of retroreflectors is two (or more than two retroreflectors in some other embodiments), which are used for increasing the frame rate and balancing rotation platform 2083 that is rotated by motor 2088. In some embodiments, small-emission-area LED 2030 with high brightness is used to generate input illumination beam 2031, such that beam 2031 has a small divergence angle for backlighting the LCD panel 2040 so that the optical throughput has a high optical efficiency. In some embodiments, LCD panel 2040 is driven by data signals 2049 from controller 2048, the data signals representing the successive 2D frames of a 3D representation of an object, wherein each 2D image is associated its own depth information corresponding to the distance 2071 from lens 2070 at which that respective 2D image is to be displayed, and the succession of 2D images forms a time-varying patterned beam 2041, which is retroreflected by rotating horizontal retroreflector 2010, then by stationary vertical retroreflector 2090, and then again by rotating horizontal retroreflector 2010 to form patterned beam 2042 that has a different optical path length for each 2D image, wherein patterned beam 2042 is then magnified by lens 2050 to form a focused beam 2051 that is made parallel again by large lens 2070 to form the 3D floating image 2080 that has the succession of 2D images of different slices of a 3D object that are each projected to its respective different distance 2071 from lens 2070, when scanned at a suitably high rate across distance 2081, appears to a human viewer as a 3D image due to the eye's persistence of vision.

In some embodiments (not shown), a first relay lens (such as relay lens 831 shown in FIG. 8B) is positioned between display panel 2040 and the rotating retroreflecting mirrors 2010 and 2020, and a second relay lens (such as relay lens 832 shown in FIG. 8B) is positioned between the rotating retroreflecting mirrors 2010 and 2020 and lens 2050.

In some other embodiments, rotating retroreflector optical-path-length-adjustment system 2082 is implemented as system 801 (such as shown in FIG. 8A, which provides a top view that may make system 2001 easier to understand, and FIG. 8B) that includes five rotating horizontal retroreflectors 810, 820, 830, 840 and 850. In other such embodiments, the number of rotating horizontal retroreflectors is any suitable number, such as one, two, three, four, five, six or more than six.

In still other embodiments, image-path-length system 2082 is implemented with stacked rotating retroreflectors, such as system 1601 (including a first system 801 stacked on a second system 801′, such as shown in FIG. 16), which includes the two stacked rotating retroreflectors with complementary compensating magnification factors, in order to keep a constant magnification of the 3D floating image.

In yet other embodiments, controller 2048 includes an image-scaling computational unit that is used with a single-stage image-path-length system 2082, as shown in FIG. 20, to dynamically adjust the image data sent as signal 2049, such that the size of each image frame on LCD panel 2040 is varied based on the depth data associated with that frame (i.e., the distance 2071 from lens 2070 at which that image is to be displayed) so that the 3D image 2080 that is formed has the desired perspective (i.e., the appropriate magnification for each frame).

In some embodiments (such as shown in FIG. 20, for example), the present invention provides a first apparatus that includes: an emissive display panel, such as OLED, mini-LED panel, micro-LED panel, or a display panel having a light source that illuminates the display panel to generate a first patterned optical beam; a fixed-in-place pair of orthogonally mounted planar mirrors at a fixed first location relative to the display panel; a first focusing optical element positioned at a fixed second location relative to the display panel; a second focusing optical element positioned at a fixed third location relative to the display panel; a rotating platform having one or more pairs of orthogonally mounted planar mirrors affixed to the rotating platform, wherein the first patterned optical beam is projected toward a location that is repeatedly scanned and retroreflected, by the one or more pairs of orthogonally mounted planar mirrors affixed to the rotating platform, toward the fixed-in-place pair of orthogonally mounted planar mirrors, wherein the one or more pairs of orthogonally mounted planar mirrors affixed to the rotating platform are configured: to retroreflect the first patterned optical beam toward the fixed-in-place pair of orthogonally mounted planar mirrors, which are configured to retroreflect to form a second patterned optical beam that is laterally displaced from the first optical beam, and that is antiparallel to the first optical beam, and to retroreflect the second optical beam toward the first focusing optical element, and wherein the first focusing optical element is configured to focus the second patterned optical beam toward the second focusing optical element, and wherein the second focusing optical element is configured to form a floating image based on the enlarged second patterned optical beam.

In some embodiments of the first apparatus, the one or more pairs of orthogonally mounted planar mirrors are moved in a rotational path by the rotating platform, wherein the rotational path has an inner circumference and an outer circumference, and wherein the display panel, the first focusing optical element and the second focusing optical element are positioned outside the outer circumference.

In some embodiments of the first apparatus, the one or more pairs of orthogonally mounted planar mirrors are moved in a rotational path by the rotating platform, wherein the rotational path has an inner circumference and an outer circumference, and wherein the display panel, the first focusing optical element and the second focusing optical element are positioned inside the inner circumference.

In some embodiments of the first apparatus, the display panel is a liquid-crystal display (LCD).

In some embodiments of the first apparatus, the light source is a small emission area light-emitting device (LED).

In some embodiments, the first apparatus further includes a controller having a storage device containing a plurality of 2D images and distance information associated with each image of the plurality of 2D images, wherein the display panel is a liquid-crystal display (LCD), and wherein the controller is configured to drive the LCD with a signal based on the plurality of 2D images and distance information such that the floating image is a moving 3D representation of an object.

In some embodiments of the first apparatus, the floating image, as viewed by a human, is a moving floating image. In some embodiments of the first apparatus, the floating image, as viewed by a human, is a moving floating virtual image, wherein the first focusing optical element is configured to enlarge the second patterned optical beam toward the second focusing optical element, and wherein the second focusing optical element is configured to form a floating image based on the enlarged second patterned optical beam.

In some embodiments, the first apparatus further includes a controller having a storage device containing data corresponding to a 3D representation of an object, wherein the data includes a plurality of 2D images and distance information for each one of the plurality of 2D images, wherein the display panel is a liquid-crystal display (LCD), and wherein the controller is configured to drive the LCD with a signal based on the plurality of 2D images and the distance information such that the floating image is the 3D representation of the object.

In some embodiments, the first apparatus further includes a focus-shift microscope imaging system operably coupled to the controller and configured to generate the plurality of 2D images, wherein each 2D image of the plurality of 2D images corresponds to a photomicrograph of an object at a different focal plane obtained by the microscope imaging system.

In some embodiments of the first apparatus, the focus-shift microscope imaging system includes a rotating platform having a plurality of retroreflectors mounted to the rotating platform.

In some embodiments (such as shown in FIGS. 6-16, for example), the present invention provides a second apparatus that includes: a microscope objective lens; a first optical-path-length-adjustment system that includes: a first rotatable mirror assembly that is rotatable to a plurality of different angles and that is operably coupled: to receive an input optical beam from the microscope objective that propagates along an input optical axis that passes through a defined input point, and to form a first intermediate beam that is antiparallel to the input optical beam, wherein the first mirror assembly includes two planar mirrors mounted at right angles to one another; and a second mirror assembly that is in a fixed position and orientation relative to the input beam, and that is operably coupled to receive the first intermediate beam and to form a second intermediate beam that is antiparallel to the first intermediate beam and laterally offset from the first intermediate beam, wherein the first mirror assembly is operably coupled to receive the second intermediate beam and to form an output beam that propagates along an output optical axis that passes through a defined output point and remains in a fixed position and angular orientation as the first optical-beam-deflection assembly is rotated to any of the plurality of different angles in order to change a first optical path length between the defined input point and the defined output point, and an imaging device operably coupled to receive the output beam and configured to generate a plurality of 2D images of an object, wherein each one of plurality of 2D images represents a slice of an object as focused at a different focal length from the microscope objective lens.

In some embodiments, the second apparatus further includes a first relay lens operably coupled to an input port of the optical-path-length-adjustment system; a second relay lens operably coupled to an output port of the optical-path-length-adjustment system; and a tube lens, wherein the second relay lens forms a parallel image beam directed through the tube lens and the tube lens focuses the image beam onto the imaging device.

In some embodiments (such as shown in FIGS. 12-16, for example), the second apparatus further includes a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system.

In some embodiments (such as shown in FIGS. 15-16, for example), the second apparatus further includes a rotary motor operably coupled to a rotating platform; a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system, wherein the second optical-path-length-adjustment system is stacked on the first optical-path-length-adjustment system and the first and second optical-path-length-adjustment systems are mounted to the rotating platform to be rotated together by the motor.

In some embodiments (such as shown in FIG. 14, for example), the second apparatus further includes an oscillatory actuator operably coupled to a rotatable platform; a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system, wherein the second optical-path-length-adjustment system is stacked on the first optical-path-length-adjustment system and the first and second optical-path-length-adjustment systems are mounted to the rotatable platform to be rotated together by the oscillatory actuator.

In some embodiments (such as shown in FIG. 14, for example), the second apparatus further includes a first oscillatory actuator operably coupled to a first rotatable platform, wherein the first rotatable mirror assembly is mounted to the first rotatable platform; a second oscillatory actuator operably coupled to a second rotatable platform; a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system, wherein the first mirror assembly is mounted to the first rotatable platform wherein the second optical-path-length-adjustment system includes a second rotatable mirror assembly, wherein the second rotatable mirror assembly is mounted to the second rotatable platform; and a controller operably coupled to control oscillatory rotation of the first and second rotatable mirror assemblies and configured to compensate for magnification factors such that an overall magnification factor of the system remains constant over a range of first optical path lengths of the first optical-path-length-adjustment system that would otherwise change the magnification factor of the first optical-path-length-adjustment system.

In some embodiments (such as shown in FIG. 9, for example), the second apparatus further includes a scanning light-sheet generator that outputs a planar light sheet that moves across a scanned volume; and a controller operably coupled to control oscillatory rotary motion of the first rotatable mirror assembly and to control movement of the planar light sheet in synchrony to a variable-position focal plane of the microscope objective.

In some embodiments, the second apparatus further includes a scanning light-sheet generator (e.g., a scanning light-sheet generator such as shown in FIG. 9 combined with other embodiment described herein, for example) that outputs a planar light sheet that moves across a scanned volume; and a controller operably coupled to control a rotational motion of the first rotatable mirror assembly and to control movement of the planar light sheet in synchrony to a variable-position focal plane of the microscope objective.

In some embodiments, the second apparatus further includes: a rotary motor operably coupled to a rotating platform; a second optical-path-length-adjustment system configured such that the first optical-path-length-adjustment system and the second optical-path-length-adjustment system together provide compensating magnification factors relative to each other such that an overall magnification factor of the system remains constant over a range of first optical path lengths of the first optical-path-length-adjustment system that would otherwise change the magnification factor of the first optical-path-length-adjustment system, wherein the second optical-path-length-adjustment system is stacked on the first optical-path-length-adjustment system and the first and second optical-path-length-adjustment systems are mounted to the rotating platform to be rotated together by the rotary motor, wherein the second apparatus further includes: first relay lens configured to direct light from the microscope objective lens into the first optical-path-length-adjustment system, a second relay lens configured to direct light out of the first optical-path-length-adjustment system, a third relay lens configured to direct light from the first optical-path-length-adjustment system into the second optical-path-length-adjustment system, and a fourth relay lens configured to direct light out of the second optical-path-length-adjustment system; and wherein the first rotatable mirror assembly of the first optical-path-length-adjustment system is moved in a rotational path by the rotating platform, wherein the rotational path has an inner circumference and an outer circumference, and wherein the first relay lens, the second relay lens, the third relay lens and the fourth relay lens are positioned outside the outer circumference.

In some embodiments, the second apparatus further includes: a rotary motor operably coupled to a rotating platform; a second optical-path-length-adjustment system configured such that the first optical-path-length-adjustment system and the second optical-path-length-adjustment system together provide compensating magnification factors relative to each other such that an overall magnification factor of the system remains constant over a range of first optical path lengths of the first optical-path-length-adjustment system that would otherwise change the magnification factor of the first optical-path-length-adjustment system, wherein the second optical-path-length-adjustment system is stacked on the first optical-path-length-adjustment system and the first and second optical-path-length-adjustment systems are mounted to the rotating platform to be rotated together by the rotary motor, wherein the second apparatus further includes: first relay lens configured to direct light from the microscope objective lens into the first optical-path-length-adjustment system, a second relay lens configured to direct light out of the first optical-path-length-adjustment system, a third relay lens configured to direct light from the first optical-path-length-adjustment system into the second optical-path-length-adjustment system, and a fourth relay lens configured to direct light out of the second optical-path-length-adjustment system; and wherein the first rotatable mirror assembly of the first optical-path-length-adjustment system is moved in a rotational path by the rotating platform, wherein the rotational path has an inner circumference and an outer circumference, and wherein the first relay lens, the second relay lens, the third relay lens and the fourth relay lens are positioned inside the inner circumference.

In some embodiments, the present invention provides a first method that includes: generating a first patterned optical beam from an illuminated display panel driven by a signal that includes a plurality of two-dimensional (2D) image frames in a sequence; rotating a platform having one or more pairs of retroreflecting planar mirrors affixed to the rotating platform; focusing the first patterned optical beam toward a location that is repeatedly scanned by the one or more pairs of rotating retroreflecting planar mirrors; retroreflecting the first patterned optical beam by the one or more pairs of rotating retroreflecting planar mirrors, toward a fixed-in-place pair of retroreflecting planar mirrors; retroreflecting the first patterned optical beam by the fixed-in-place pair of retroreflecting planar mirrors to form a second patterned optical beam that is laterally displaced from the first optical beam, and that is antiparallel to the first optical beam and directed back toward the one or more pairs of rotating retroreflecting planar mirrors; retroreflecting the second patterned optical beam by the one or more pairs of rotating retroreflecting planar mirrors, toward a first focusing optical element, and focusing the second patterned optical beam by the first focusing optical element to focus the second patterned optical beam such that the second patterned beam is enlarged toward a second focusing optical element, and forming a floating image by the second focusing optical element based on the enlarged second patterned optical beam.

In some embodiments of the first method, the one or more pairs of retroreflecting planar mirrors are moved in a rotational path by the rotating platform, wherein the rotational path has an inner circumference and an outer circumference, and wherein the display panel, the first focusing optical element and the second focusing optical element are positioned outside the outer circumference.

In some embodiments of the first method, the one or more pairs of orthogonally mounted planar mirrors are moved in a rotational path by the rotating platform, wherein the rotational path has an inner circumference and an outer circumference, and wherein the display panel, the first focusing optical element and the second focusing optical element are positioned inside the inner circumference.

In some embodiments of the first method, the display panel is a liquid-crystal display (LCD).

In some embodiments of the first method, the light source is a small emission area light-emitting device (LED).

Some embodiments of the first method further include providing a controller having a storage device containing the plurality of 2D images and distance information associated with each image of the plurality of 2D images, wherein the display panel is a liquid-crystal display (LCD), and wherein the controller is configured to drive the LCD with a signal based on the plurality of 2D images and distance information such that the floating image is a moving 3D representation of an object.

In some embodiments of the first method, the floating image as viewed by a human is a moving floating image.

Some embodiments of the first method further include providing a controller having a storage device containing data corresponding to a 3D representation of an object, wherein the data includes a plurality of 2D images and distance information for each one of the plurality of 2D images, wherein the display panel is a liquid-crystal display (LCD), and wherein the controller is configured to drive the LCD with a signal based on the plurality of 2D images and the distance information such that the floating image is the 3D representation of the object.

Some embodiments of the first method further include providing a focus-shift microscope imaging system operably coupled to the controller and configured to generate the plurality of 2D images, wherein each 2D image of the plurality of 2D images corresponds to a photomicrograph of an object at a different focal plane obtained by the microscope imaging system. In some such embodiments, the focus-shift microscope imaging system includes a rotating platform having a first plurality of retroreflectors mounted to the rotating platform and a second plurality of retroreflectors stacked on the first plurality of retroreflectors.

In some embodiments, the present invention provides a second method that includes: forming an input image beam from a microscope objective lens; rotating a first rotatable retroreflecting mirror pair to a plurality of different angles; receiving the input image beam from the microscope objective that propagates along an input optical axis that passes through a defined input point, and forming a first intermediate beam that is antiparallel to the input image beam, wherein the first rotatable retroreflecting mirror pair includes two planar mirrors mounted at right angles to one another; and receiving the first intermediate beam by a second retroreflecting mirror pair that is in a fixed position and orientation relative to the input beam, and forming a second intermediate beam that is antiparallel to the first intermediate beam and laterally offset from the first intermediate beam; receiving the second intermediate beam by the first rotatable retroreflecting mirror pair and forming an output beam that propagates along an output optical axis that passes through a defined output point and remains in a fixed position and angular orientation as the first rotatable retroreflecting mirror pair is rotated to any of the plurality of different angles in order to change a first optical path length between the defined input point and the defined output point, and generating a plurality of 2D images of an object using an imaging device operably coupled to receive the output beam, wherein each one of plurality of 2D images represents a slice of an object as focused at a different focal length from the microscope objective lens.

Some embodiments of the second method further include: positioning a first relay lens between the microscope objective lens and the first rotatable retroreflecting mirror pair; and positioning a second relay lens between the first rotatable retroreflecting mirror pair and a tube lens, wherein the second relay lens forms a parallel image beam directed through the tube lens and the tube lens focuses the image beam onto the imaging device.

Some embodiments of the second method further include providing a compensating magnification factor such that an overall magnification factor of the method remains constant over a range of optical path lengths.

Some embodiments of the second method further include: generating a scanning planar light sheet that moves across a scanned volume; and controlling movement of the planar light sheet in synchrony with a rotational motion of the first rotatable retroreflecting mirror pair that provides light-sheet illumination limited to a variable-position focal plane of the microscope objective.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. An apparatus comprising:
an illuminated display panel having a light source that illuminates the display panel, wherein the display panel is driven by a data signal that includes a plurality of two-dimensional (2D) image frames in a sequence to generate a first patterned optical beam;
a fixed-in-place pair of orthogonally mounted planar mirrors at a fixed first location relative to the display panel;
a first focusing optical element positioned at a fixed second location relative to the display panel;
a second focusing optical element positioned at a fixed third location relative to the display panel;
a rotating platform having one or more pairs of orthogonally mounted planar mirrors affixed to the rotating platform,
wherein the first patterned optical beam is projected toward a location that is repeatedly scanned and retroreflected, by the one or more pairs of orthogonally mounted planar mirrors affixed to the rotating platform, toward the fixed-in-place pair of orthogonally mounted planar mirrors,
wherein the one or more pairs of orthogonally mounted planar mirrors affixed to the rotating platform are configured:
to retroreflect the first patterned optical beam toward the fixed-in-place pair of orthogonally mounted planar mirrors, which are configured to retroreflect to form a second patterned optical beam that is laterally displaced from the first optical beam, and that is antiparallel to the first optical beam, and
to retroreflect the second optical beam toward the first focusing optical element, and
wherein the first focusing optical element is configured to focus the second patterned optical beam toward the second focusing optical element, and
wherein the second focusing optical element is configured to form a floating image based on the enlarged second patterned optical beam.

2. The apparatus of claim 1, wherein the one or more pairs of orthogonally mounted planar mirrors are moved in a rotational path by the rotating platform, wherein the rotational path has an inner circumference and an outer circumference, and wherein the display panel, the first focusing optical element and the second focusing optical element are positioned outside the outer circumference.

3. The apparatus of claim 1, wherein the one or more pairs of orthogonally mounted planar mirrors are moved in a rotational path by the rotating platform, wherein the rotational path has an inner circumference and an outer circumference, and wherein the display panel, the first focusing optical element and the second focusing optical element are positioned inside the inner circumference.

4. The apparatus of claim 1, wherein the display panel is a liquid-crystal display (LCD).

5. The apparatus of claim 1, wherein the light source is a small emission area light-emitting device (LED).

6. The apparatus of claim 1, further comprising a controller having a storage device containing a plurality of 2D images and distance information associated with each image of the plurality of 2D images, wherein the display panel is a liquid-crystal display (LCD), and wherein the controller is configured to drive the LCD with a signal based on the plurality of 2D images and distance information such that the floating image is a moving 3D representation of an object.

7. The apparatus of claim 1, wherein the floating image, as viewed by a human, is a moving floating image.

8. The apparatus of claim 1, further comprising a controller having a storage device containing data corresponding to a 3D representation of an object, wherein the data includes a plurality of 2D images and distance information for each one of the plurality of 2D images, wherein the display panel is a liquid-crystal display (LCD), and wherein the controller is configured to drive the LCD with a signal based on the plurality of 2D images and the distance information such that the floating image is the 3D representation of the object.

9. The apparatus of claim 8, further comprising a focus-shift microscope imaging system operably coupled to the controller and configured to generate the plurality of 2D images, wherein each 2D image of the plurality of 2D images corresponds to a photomicrograph of an object at a different focal plane obtained by the microscope imaging system.

10. The apparatus of claim 9, wherein the focus-shift microscope imaging system includes a rotating platform having a plurality of retroreflectors mounted to the rotating platform.

11. An apparatus comprising:
a microscope objective lens;
a first optical-path-length-adjustment system that includes:
a first rotatable mirror assembly that is rotatable to a plurality of different angles and that is operably coupled:
to receive an input optical beam from the microscope objective that propagates along an input optical axis that passes through a defined input point, and
to form a first intermediate beam that is antiparallel to the input optical beam, wherein the first mirror assembly includes two planar mirrors mounted at right angles to one another; and
a second mirror assembly that is in a fixed position and orientation relative to the input beam, and that is operably coupled to receive the first intermediate beam and to form a second intermediate beam that is antiparallel to the first intermediate beam and laterally offset from the first intermediate beam, wherein the first mirror assembly is operably coupled to receive the second intermediate beam and to form an output beam that propagates along an output optical axis that passes through a defined output point and remains in a fixed position and angular orientation as the first optical-beam-deflection assembly is rotated to any of the plurality of different angles in order to change a first optical path length between the defined input point and the defined output point, and
an imaging device operably coupled to receive the output beam and configured to generate a plurality of two-dimensional (2D) images of an object, wherein each one of plurality of 2D images represents a slice of an object as focused at a different focal length from the microscope objective lens.

12. The apparatus of claim 11, further comprising:
a first relay lens operably coupled to an input port of the optical-path-length-adjustment system;
a second relay lens operably coupled to an output port of the optical-path-length-adjustment system; and
a tube lens, wherein the second relay lens forms a parallel image beam directed through the tube lens and the tube lens focuses the image beam onto the imaging device.

13. The apparatus of claim 11, further comprising:
a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system.

14. The apparatus of claim 11, further comprising:
a rotary motor operably coupled to a rotating platform;
a second optical-path-length-adjustment system configured to provide a compensating magnification factor relative to a magnification factor of the first optical-path-length-adjustment system such that an overall magnification factor of the system remains constant over a range of first optical path lengths of the first optical-path-length-adjustment system that would otherwise change the magnification factor of the first optical-path-length-adjustment system, wherein the second optical-path-length-adjustment system is stacked on the first optical-path-length-adjustment system and the first and second optical-path-length-adjustment systems are mounted to the rotating platform to be rotated together by the motor.

15.-18. (canceled)

19. The apparatus of claim 11, further comprising:
a rotary motor operably coupled to a rotating platform;
a second optical-path-length-adjustment system configured such that the first optical-path-length-adjustment system and the second optical-path-length-adjustment system together provide compensating magnification factors relative to each other such that an overall magnification factor of the system remains constant over a range of first optical path lengths of the first optical-path-length-adjustment system that would otherwise change the magnification factor of the first optical-path-length-adjustment system,
wherein the second optical-path-length-adjustment system is stacked on the first optical-path-length-adjustment system and the first and second optical-path-length-adjustment systems are mounted to the rotating platform to be rotated together by the rotary motor,
wherein the apparatus further includes:
a first relay lens configured to direct light from the microscope objective lens into the first optical-path-length-adjustment system,
a second relay lens configured to direct light out of the first optical-path-length-adjustment system,
a third relay lens configured to direct light from the first optical-path-length-adjustment system into the second optical-path-length-adjustment system, and
a fourth relay lens configured to direct light out of the second optical-path-length-adjustment system; and
wherein the first rotatable mirror assembly of the first optical-path-length-adjustment system is moved in a rotational path by the rotating platform, wherein the rotational path has an inner circumference and an outer circumference, and wherein the first relay lens, the second relay lens, the third relay lens and the fourth relay lens are positioned outside the outer circumference.

20. The apparatus of claim 11, further comprising:
a rotary motor operably coupled to a rotating platform;
a second optical-path-length-adjustment system configured such that the first optical-path-length-adjustment system and the second optical-path-length-adjustment system together provide compensating magnification factors relative to each other such that an overall magnification factor of the system remains constant over a range of first optical path lengths of the first optical-path-length-adjustment system that would otherwise change the magnification factor of the first optical-path-length-adjustment system,
wherein the second optical-path-length-adjustment system is stacked on the first optical-path-length-adjustment system and the first and second optical-path-length-adjustment systems are mounted to the rotating platform to be rotated together by the rotary motor,
wherein the apparatus further includes:
a first relay lens configured to direct light from the microscope objective lens into the first optical-path-length-adjustment system,
a second relay lens configured to direct light out of the first optical-path-length-adjustment system,
a third relay lens configured to direct light from the first optical-path-length-adjustment system into the second optical-path-length-adjustment system, and
a fourth relay lens configured to direct light out of the second optical-path-length-adjustment system; and
wherein the first rotatable mirror assembly of the first optical-path-length-adjustment system is moved in a rotational path by the rotating platform, wherein the rotational path has an inner circumference and an outer circumference, and wherein the first relay lens, the second relay lens, the third relay lens and the fourth relay lens are positioned inside the inner circumference.

21.-30. (canceled)

31. A method comprising:
forming an input image beam from a microscope objective lens;
rotating a first rotatable retroreflecting mirror pair to a plurality of different angles;
receiving the input image beam from the microscope objective that propagates along an input optical axis that passes through a defined input point;
forming a first intermediate beam that is antiparallel to the input image beam, wherein the first rotatable retroreflecting mirror pair includes two planar mirrors mounted at right angles to one another;
receiving the first intermediate beam by a second retroreflecting mirror pair that is in a fixed position and orientation relative to the input beam, and forming a second intermediate beam that is antiparallel to the first intermediate beam and laterally offset from the first intermediate beam;
receiving the second intermediate beam by the first rotatable retroreflecting mirror pair and forming an output beam that propagates along an output optical axis that passes through a defined output point and remains in a fixed position and angular orientation as the first rotatable retroreflecting mirror pair is rotated to any of the plurality of different angles in order to change a first optical path length between the defined input point and the defined output point; and
generating a plurality of 2D images of an object using an imaging device operably coupled to receive the output beam, wherein each one of plurality of 2D images represents a slice of an object as focused at a different focal length from the microscope objective lens.

32. The method of claim 31, further comprising:
positioning a first relay lens between the microscope objective lens and the first rotatable retroreflecting mirror pair; and
positioning a second relay lens between the first rotatable retroreflecting mirror pair and a tube lens, wherein the second relay lens forms a parallel image beam directed through the tube lens and the tube lens focuses the image beam onto the imaging device.

33. The method of claim 31, further comprising providing a compensating magnification factor such that an overall magnification factor of the method remains constant over a range of optical path lengths.

34. The method of claim 31, further comprising:
generating a scanning planar light sheet that moves across a scanned volume; and
controlling movement of the planar light sheet in synchrony with a rotational motion of the first rotatable retroreflecting mirror pair that provides light-sheet illumination limited to a variable-position focal plane of the microscope objective.
